(19) United States
(12) Patent Application Publication
(10) Pub. No.: US 2025/0378257 A1
(43) Pub. Date: Dec. 11, 2025

(54) SENSORY DISTANCE INFORMATION GENERATION PROGRAM, SENSORY DISTANCE INFORMATION GENERATION METHOD, AND SENSORY DISTANCE INFORMATION GENERATION APPARATUS

(71) Applicant: Datascientist Inc., Tokyo (JP)

(72) Inventors: Naoya SAKAKIBARA, Tokyo (JP); Yuki HIROBE, Tokyo (JP)

(73) Assignee: Datascientist Inc., Tokyo (JP)

(21) Appl. No.: 18/695,972

(22) PCT Filed: Oct. 21, 2021
(86) PCT No.: PCT/JP2021/038864

§ 371 Date: Jan. 15, 2025

(51) Int. Cl. G06F 40/106; G06F 17/18; G06F 40/134; G06F 40/14

(52) U.S. Cl. CPC G06F 40/106; G06F 17/18; G06F 40/134; G06F 40/14

(57) ABSTRACT

Provided are a sensory distance information generation program, a sensory distance information generation method, and a sensory distance information generation apparatus for generating information indicating a sensory distance between arbitrary electronic media such as web pages. Provided is a sensory distance information generation program causing a computer to function as a sensory distance calculator that calculates a first sensory distance for transitioning from a first electronic medium to a second electronic medium by analyzing the first electronic medium, and a sensory distance information generator that generates sensory distance information indicating a relationship between the first electronic medium and the second electronic medium based on the first sensory distance.

### TECHNICAL FIELD

The present invention relates to a sensory distance information generation program, a sensory distance information generation method, and a sensory distance information generation apparatus.

### BACKGROUND ART

Patent Literature 1 discloses an invention for presenting hierarchical data, which is titled “Visualization of Site Structure and Enablement of Site Navigation for Search Results or Linked Pages”.

### CITATION LIST

### Patent Literature

Patent Literature 1: JP 2012-515382 A

### SUMMARY OF INVENTION

### Technical Problem

It is difficult to grasp a sensory distance with conventional hierarchical data.

Therefore, an object of the present invention is to provide a sensory distance information generation program, a sensory distance information generation method, and a sensory distance information generation apparatus for generating information indicating a sensory distance between arbitrary electronic media such as web pages.

### Solution to Problem

According to one embodiment, provided is a sensory distance information generation program causing a computer to function as: a sensory distance calculator that calculates a first sensory distance for transitioning from a first electronic medium to a second electronic medium by analyzing the first electronic medium; and a sensory distance information generator that generates sensory distance information indicating a relationship between the first electronic medium and the second electronic medium based on the first sensory distance.

The first electronic medium may be a first screen, and the second electronic medium may be a second screen.

The first electronic medium may be first web page, and the second electronic medium may be a second web page.

The sensory distance calculator may calculate the first sensory distance by applying a predetermined reference.

The predetermined reference may include a first reference and a second reference, and the sensory distance calculator may calculates the first sensory distance based on a value obtained by adding, by using a predetermined weight, a second sensory distance for transitioning from the first electronic medium to the second electronic medium in a case where the first reference is applied and a third sensory distance for transitioning from the first electronic medium to the second electronic medium in a case where the second reference is applied.

The sensory distance calculator may calculate the first sensory distance based on a value obtained by adding a plurality of second sensory distances for transitioning from the first electronic medium to the second electronic medium, by using a predetermined weight.

The first electronic medium may be a first screen, and the second electronic medium may be a second screen, and the sensory distance calculator may calculate the first sensory distance based on a value obtained by adding, by using a predetermined weight, a second sensory distance for transitioning from the first electronic medium to the second electronic medium in a case where the first screen is displayed on a first device, and a third sensory distance for transitioning from the first electronic medium to the second electronic medium in a case where the second screen is displayed on a second device.

The weight bay be settable by a user.

The sensory distance calculator may calculate the first sensory distance based on an interface contained in the first electronic medium for transitioning from the first electronic medium to the second electronic medium.

The first electronic medium may be the first screen, and the second electronic medium may be the second screen, and the interface may be a link.

The first electronic medium may be the first screen, and the second electronic medium may be the second screen, and the sensory distance calculator may calculate the first sensory distance based on a display position of the interface in the first electronic medium.

The first electronic medium may include an additional interface for transitioning from the first electronic medium to a third electronic medium in addition to the interface for transitioning from the first electronic medium to the second electronic medium, and the sensory distance calculator may calculate the first sensory distance in consideration of a positional relationship between the interface and the additional interface.

The sensory distance calculator may calculate the first sensory distance in consideration of a user operation required to access the interface.

The sensory distance calculator may calculate the first sensory distance in consideration of a number of user operations on an operation device required to access the interface.

The sensory distance calculator may calculate the first sensory distance in consideration of a distance required for the user to move the operation device to access the interface.

The sensory distance calculator may calculate the first sensory distance in consideration of ease of perception of the interface.

The sensory distance calculator may calculate the first sensory distance in consideration of at least one of a size, a thickness, a color, a position, or a text font of the interface.

The sensory distance calculator may calculate the first sensory distance in consideration of a time taken for the user to become accessible to the interface.

The sensory distance calculator may calculate the first sensory distance in consideration of a time from when the user accesses the interface to when transition to the second electronic medium is made.

The sensory distance calculator may calculate the first sensory distance in consideration of a time required for transition from the first electronic medium to the second electronic medium.

The sensory distance calculator may calculate the first sensory distance in consideration of an actual result of transition from the first electronic medium to the second electronic medium.

The first electronic medium may be the first screen, and the second electronic medium may be the second screen, and the sensory distance calculator may calculate the first sensory distance in consideration of a device on which the first screen is displayed.

The sensory distance calculator may calculate a fourth sensory distance for transitioning from the first electronic medium to a plurality of third electronic media by analyzing the first electronic medium, and calculate the first sensory distance assuming the third electronic medium whose fourth sensory distance satisfies a predetermined condition as the second electronic medium, but does not calculate the first sensory distance for the third electronic medium whose third sensory distance does not satisfy the predetermined condition.

The sensory distance calculator may calculate a semantic distance indicating how close content of the first electronic medium and the second electronic medium is, the sensory distance information generation program may further cause the computer to function as an output controller that issues an alert in a case where the first sensory distance and the semantic distance satisfy a predetermined relationship.

The predetermined relationship may be a relationship in which the first sensory distance is equal to or larger than a first threshold and the semantic distance is equal to or smaller than a second threshold, a relationship in which the first sensory distance is equal to or smaller than a third threshold and the semantic distance is equal to or larger than a fourth threshold, or a relationship in which a difference between the first sensory distance and the semantic distance is equal to or larger than a fifth threshold.

The sensory distance information generation program may further cause the computer to function as: the output controller that causes a display to display information indicating a plurality of electronic media; and a setter that sets an electronic medium selected from the plurality of electronic media as the first electronic medium and sets at least one of other electronic media as the second electronic medium.

The output controller may cause the display to display the first sensory distance in association with the second electronic medium.

The sensory distance calculator may calculate the semantic distance indicating how close the content of the first electronic medium and the second electronic medium is, and the output controller may cause the display to display the semantic distance in association with the second electronic medium.

The output unit may sort the plurality of electronic media in an order of the first sensory distances and causes the display to display the sorted electronic media.

The sensory distance information generation program may further cause the computer to function as the output controller that displays the sensory distance information as a site map.

The site map may contain a symbol corresponding to the second electronic medium, and at least one of a display position or a display aspect of the symbol may correspond to the first sensory distance.

The sensory distance calculator may calculate the semantic distance indicating how close the content of the first electronic medium and the second electronic medium is, and another at least one of the display position or the display aspect of the symbol may correspond to the semantic distance.

The site map may contain a first symbol corresponding to the first electronic medium, a symbol corresponding to the second electronic medium, and a path associated with the first symbol and the second symbol, and a display aspect of the path may corresponds to the first sensory distance.

The first symbol and the second symbol a may be arranged based on a hierarchical relationship between the first electronic medium and the second electronic medium.

The first electronic medium may be a first screen, and the second electronic medium may be a second screen, the first screen may contain a link for transitioning from the first screen to the second screen, and the sensory distance calculator may calculate the first sensory distance in consideration of a display position of the link.

The sensory distance information generation program may further cause the computer to function as a setter that sequentially displays icons at respective positions on a display, receives selection of the displayed icon from a user, and generates a sensory distance calculation reference indicating a relationship between a position on the display and a sensory distance based on a time from when the icon is displayed on the display to when the icon is selected by the user, wherein the sensory distance calculator may calculate the sensory distance based on the display position of the link and the sensory distance calculation reference.

The sensory distance information generation program may further cause the computer to function as a setter that divides a display region of a display to display a plurality of divided regions, receives, from a user, information regarding a length of a sensory distance for each of the plurality of divided regions, and generates a sensory distance calculation reference indicating a relationship between a position on the display and the sensory distance based on the received information, wherein the sensory distance calculator may calculate the sensory distance based on the display position of the link and the sensory distance calculation reference.

The sensory distance information generation program may further cause the computer to function as a setter that displays icons at respective positions on a display, receives, from a user, information regarding a length of a sensory distance for each of the icons, and generates a sensory distance calculation reference indicating a relationship between a position on the display and the sensory distance based on the received information, wherein the sensory distance calculator calculates the sensory distance based on the display position of the link and the sensory distance calculation reference.

According to one embodiment, provided is a sensory distance information generation method comprising: calculating, by a sensory distance calculator, a first sensory distance for transitioning from a first electronic medium to a second electronic medium by analyzing the first electronic medium; and generating, by a sensory distance information generator, sensory distance information indicating a relationship between the first electronic medium and the second electronic medium based on the first sensory distance.

According to one embodiment, provided is a sensory distance information generation apparatus comprising: a sensory distance calculator that calculates a first sensory distance for transitioning from a first electronic medium to a second electronic medium by analyzing the first electronic medium; and a sensory distance information generator that generates sensory distance information indicating a relationship between the first electronic medium and the second electronic medium based on the first sensory distance.

### Advantageous Effects of Invention

It is possible to generate information indicating a sensory distance between arbitrary electronic media such as web pages.

### BRIEF DESCRIPTION OF DRAWINGS

FIG. 1A is a view illustrating uniform resource locators (URLs) of three web pages W0 to W2.

FIG. 1B is a diagram schematically illustrating the web page W0.

FIG. 2A is a diagram illustrating a site map based on a hierarchical relationship (directory structure) of the web pages W0 to W2.

FIG. 2B is a diagram illustrating an example of a site map according to the present embodiment.

FIG. 3 is a block diagram illustrating a schematic configuration of a site map generation apparatus according to an embodiment.

FIG. 4A is a diagram schematically illustrating the reference web page W0 containing links L11 to L19.

FIG. 4B is a diagram for describing a physical distance (inverted N shape).

FIG. 4C is a diagram for describing a physical distance (Z shape).

FIG. 4D is a diagram for describing a physical distance (inverted Z shape).

FIG. 4E is a diagram for describing a physical distance (F shape).

FIG. 5A is a view illustrating a relationship with a physical distance calculation reference in a case where a layout of the reference web page is in a single column format.

FIG. 5B is a view illustrating a relationship with a physical distance calculation reference in a case where the layout of the reference web page is in a multi-column format.

FIG. 5C is a view illustrating a relationship with a physical distance calculation reference in a case where the layout of the reference web page is in a grid format.

FIG. 6A is a diagram for describing a relationship between a device movement amount and an operation distance.

FIG. 6B is a view for describing the device movement amount.

FIG. 7 is a view for describing the number of device operations.

FIG. 8A is a view for describing the number of device operations.

FIG. 8B is a view for describing the number of device operations.

FIG. 9 is a view for describing a device-dependent sensory distance.

FIG. 10 is a diagram schematically illustrating a concept of sensory distance calculation.

FIG. 11A is a flowchart illustrating an example of a processing operation of the site map generation apparatus.

FIG. 11B is a flowchart illustrating another example of the processing operation of the site map generation apparatus.

FIG. 12A is a view schematically illustrating an example of a setting screen displayed on a display 6.

FIG. 12B is a view schematically illustrating another example of the setting screen displayed on the display 6.

FIG. 13A is a schematic diagram illustrating an example of the site map.

FIG. 13B is a schematic diagram illustrating an example of the site map.

FIG. 14A is a schematic diagram illustrating another example of the site map.

FIG. 14B is a schematic diagram illustrating another example of the site map.

FIG. 15 is a schematic diagram illustrating another example of the site map.

FIG. 16 is a schematic diagram illustrating another example of the site map.

FIG. 17 is a schematic diagram illustrating another example of the site map.

FIG. 18A is a schematic diagram illustrating another example of the site map.

FIG. 18B is a schematic diagram illustrating another example of the site map.

FIG. 19A is a diagram for describing an example of the processing operation of the site map generation apparatus.

FIG. 19B is a diagram for describing an example of the processing operation of the site map generation apparatus.

FIG. 19C is a diagram for describing an example of the processing operation of the site map generation apparatus.

FIG. 20A is a diagram for describing another example of the processing operation of the site map generation apparatus.

FIG. 20B is a diagram for describing another example of the processing operation of the site map generation apparatus.

FIG. 21A is a view for describing an example of a user setting method for the physical distance calculation reference.

FIG. 21B is a view for describing an example of the user setting method for the physical distance calculation reference.

FIG. 21C is a view for describing an example of the user setting method for the physical distance calculation reference.

FIG. 22 is a view for describing an example of the user setting method for the physical distance calculation reference.

FIG. 23 is a view for describing an example of the user setting method for the physical distance calculation reference.

FIG. 24 is a view for describing another example of the user setting method for the physical distance calculation reference.

FIG. 25 is a view for describing another example of the user setting method for the physical distance calculation reference.

FIG. 26 is a view for describing another example of the user setting method for the physical distance calculation reference.

FIG. 27A is a view for describing another example of the user setting method for the physical distance calculation reference.

FIG. 27B is a view for describing another example of the user setting method for the physical distance calculation reference.

FIG. 28 is a view for describing another example of the user setting method for the physical distance calculation reference.

### DESCRIPTION OF EMBODIMENTS

Hereinafter, embodiments according to the present invention will be specifically described with reference to the drawings.

### Outline of Present Embodiment

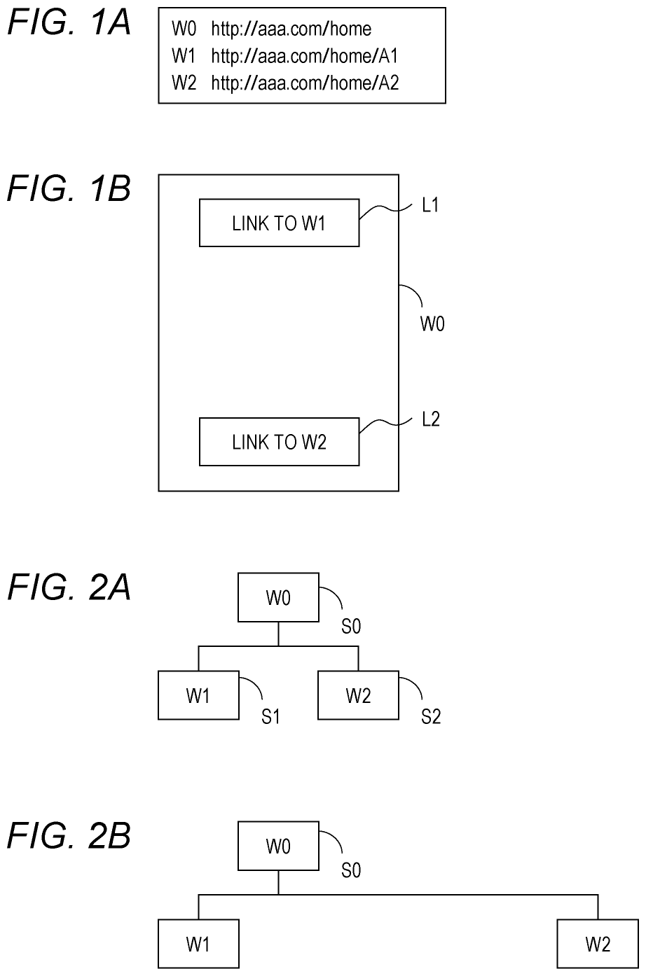

There are three web pages W0 to W2 as illustrated in FIG. 1A, and uniform resource locators (URLs) of the web pages W0 to W2 are as follows. That is, the web pages W1 and W2 one level below the web page W0 in terms of directory structure.
W0: http://aaa.com/home
W1: http://aaa.com/home/A1
W2: http://aaa.com/home/A2

The web page W0 contains a link L1 to the web page W1 and a link L2 to the web page W2 as illustrated in FIG. 1B. However, the link L1 is arranged at an easily clickable position at an upper part of the web page W0, whereas the link L2 is arranged at a hardly clickable position at a lower part of the web page W0.

A site map based on a hierarchical relationship (directory structure) of the web pages W0 to W2 as illustrated in FIG. 2A can be considered as a site map showing a structure of a web site containing the web pages W0 to W2 in a conventional method. The site map of FIG. 2A contains symbols S0 to S2 corresponding to the web pages W0 to W2, respectively, and the symbols S1 and S2 are arranged below the symbol S0. It can be seen in such a site map that there are web pages W1 and W2 one level below the web page W0 as a reference.

However, a distance between the symbol S0 and the symbol S1 and a distance between the symbol S0 and the symbol S2 are displayed equal in the site map of FIG. 2A. Therefore, it is not possible to know a sensory distance between the web page W0 and the web pages W1 and W2 for a user.

Both the web pages W1 and W2 are immediately below the web page W0 in terms of hierarchical structure. However, the link L1 to the web page W1 is easier to click according to arrangement positions of the links L1 and L2 in the web page W0 as illustrated in FIG. 1B. Therefore, the sensory distance from the web page W0 to the web page W1 is smaller than the sensory distance from the web page W0 to the web page W2.

The site map based on the hierarchical structure illustrated in FIG. 2A does not reflect the sensory distance as described above. As a result, a website creator who refers to such a site map may position web pages with highly relevant contents of which the sensory distance needs to be small far from each other or may position web pages with hardly relevant contents of which the sensory distance needs to be large close to each other.

In a case where such a web site is constructed, a user of the web site may find it difficult to find a link to a web page with a highly relevant content (the sensory distance is large) when trying to move from a browsed web page to such a web page. Furthermore, the user may unintentionally move to a web page with a hardly relevant content by clicking a link that is easy to find (the sensory distance is small).

Therefore, in the present embodiment, a site map is generated in consideration of the sensory distance as illustrated in FIG. 2B. Symbols S0 to S2 are arranged in such a way that a distance between the symbol S0 and the symbol S1 is smaller than a distance between the symbol S0 and the symbol S2 in the site map of FIG. 2B. As such a site map is generated, it can be seen that a sensory distance from the web page W0 to the web page W1 is smaller than a sensory distance from the web page W0 to the web page W2.

As described above, an object of the present embodiment is to index a sensory distance at the time of transition from a certain web page to another web page, thereby automatically generating a site map. Hereinafter, generation of the site map according to the sensory distance will be described in detail.

### <Configuration of Site Map Generation Apparatus>

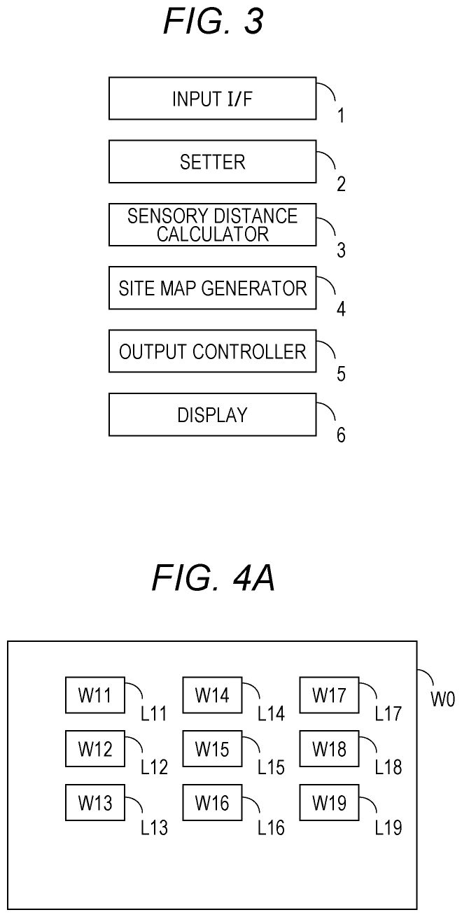

FIG. 3 is a block diagram illustrating a schematic configuration of a site map generation apparatus according to an embodiment. The site map generation apparatus (sensory distance information generation apparatus) is, for example, a personal computer or a smartphone, and includes an input interface 1, a setter 2, a sensory distance calculator 3, a site map generator 4 (sensory distance generator), an output controller 5, and a display 6.

The input interface 1 is, for example, a touch panel, a mouse, a keyboard, a microphone, a camera, an eye tracking module, or the like. The user performs an input operation on the site map generation apparatus by using the input interface 1.

The setter 2 performs various settings by receiving the input operation from the user via the input interface 1.

As an example, the setter 2 sets the web page W0 to be a reference for sensory distance measurement (hereinafter, referred to as “reference web page”). The reference web page W0 can also be referred to as an origin page for a measurement target. As a specific example, the setter 2 may receive an input of a URL from the user and set a web page specified by the URL as the reference web page W0. The reference web page W0 may be an arbitrary web page, and may be, for example, a top page (home page), a terminal page, or an intermediate page in a web site.

In addition, the setter 2 sets a web page to be a target for calculating a sensory distance from the reference web page W0 (hereinafter, referred to as “target web page”). There may be one or more target web pages.

As a specific example, the setter 2 may receive an input of one or more URLs from the user, and may set one or more web pages specified by the URLs as the target web pages. As another specific example, the setter 2 may receive an input of an upper limit number of clicks (operations) Nmax from the user, and may set, as the target web page, a web page for which transition from the reference web page W0 can be made by clicking Nmax times or less. As another specific example, the setter 2 may set, as the target web page, a web page in the same domain as the reference web page W0. As another specific example, the setter 2 may receive an input of an arbitrary domain from the user and set a web page belonging to the domain as the target web page. The setter 2 sets the target web page by any other methods.

The setter 2 sets references for determining a sensory distance calculation method and various conditions for site map display. The setting may be based on the user operation.

The sensory distance calculator 3 calculates a sensory distance between web pages. As a specific example, the sensory distance calculator 3 calculates a sensory distance at the time of transition from the reference web page W0 (first electronic medium and first screen) to the target web page (second electronic medium and second screen) by analyzing the reference web page W0. As a further specific example, the sensory distance calculator 3 can calculate the sensory distance based on a link (interface) for transitioning to the target web page, contained in the reference web page W0. As a further specific example, the sensory distance calculator 3 may calculate the sensory distance based on a display position of the link in the reference web page.

A detailed example of the sensory distance calculation will be described later. The sensory distance may be quantitatively calculated as a numerical value, or may be classified as any of a plurality of stages such as large, medium, and small (such a classification is also included in “calculation”).

The site map generator 4 generates a site map (sensory distance information) indicating a relationship between the reference web page W0 and the target web page based on the calculated sensory distance. The site map may contain symbols corresponding to the reference web page W0 and/or the target web page, and arrangement positions of the symbols or a distance between the symbols can correspond to the sensory distance. A detailed example of the site map will be described later.

The output controller 5 causes the display 6 to display a screen containing the generated site map. Alternatively, the output controller 5 may print the site map on a paper medium or the like or output the site map to an external recording medium.

The display 6 displays screens necessary for various settings under the control of the setter 2, or displays the site map under the control of the output controller 5.

Some or all of the setter 2, the sensory distance calculator 3, the site map generator 4, and the output controller 5 may be implemented by a processor of the site map generation apparatus executing a predetermined program, or may be implemented by hardware.

### <Specific Example of Sensory Distance Calculation>

Various types of sensory distances are conceivable. Hereinafter, a physical distance, an operation distance, a link path distance, a perceived distance, a temporal distance, and a user action distance are described as examples of the sensory distance. In addition, there can be a plurality of calculation references (rules) for only one type of sensory distance. The final sensory distance may be calculated in comprehensive consideration of a plurality of types of sensory distances and/or a plurality of sensory distances based on a plurality of references.

The type and reference of the sensory distance to be considered may be determined in advance, may be dynamically determined by the sensory distance calculator 3 analyzing the reference web page W0 and/or the target web page, or may be set by the user via the setter 2.

### <Physical Distance>

The sensory distance calculator 3 may calculate the sensory distance based on a physical arrangement position of a link to the target web page in the reference web page W0, and such a sensory distance is referred to as the “physical distance”.

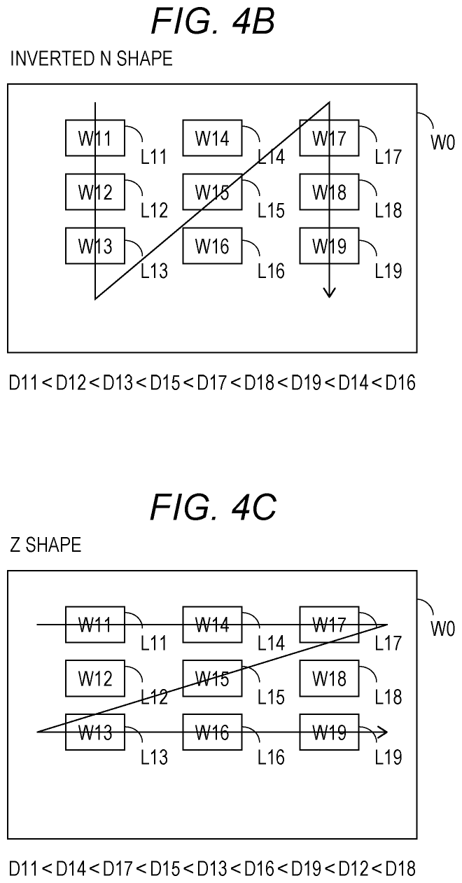

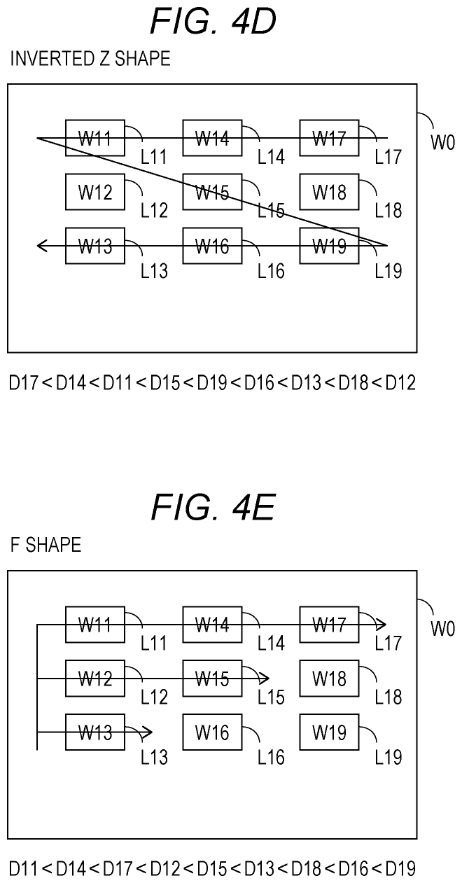

As a specific example, it is assumed that the reference web page W0 contains links L11 to L19 to a plurality of target web pages W11 to W19, and the links L11 to L19 are arranged as illustrated in FIG. 4A. Physical distances between the reference web page W0 and the target web pages W11 to W19 are defined as D11 to D19, respectively.

In this case, the sensory distance calculator 3 calculates the sensory distances D11 to D19 to the target web pages W11 to W19 in consideration of a positional relationship (relative positional relationship) between the links L11 to L19. A predetermined reference (rule) is applied to a relationship between the positional relationship and the sensory distance.

As an example of the reference, the sensory distances may be determined to form an inverted N shape as illustrated in FIG. 4B. In this case, the sensory distances D11 to D19 of the reference web page W0 between the target web pages W11 to W19 have the following relationship.

$$D 11 < D 12 < D 13 < D 16 < D 15 < D 14 < D 17 < D 18 < D 19 or$$

$$D 11 < D 12 < D 13 < D 15 < D 17 < D 18 < D 19 < D 14 < D 16$$

As another example of the reference, the sensory distances may be determined to form a Z shape as illustrated in FIG. 4C. In this case, the sensory distances D11 to D19 of the reference web page W0 between the target web pages W11 to W19 have the following relationship.

$$D 11 < D 14 < D 17 < D 18 < D 15 < D 12 < D 13 < D 16 < D 19 or$$

$$D 11 < D 14 < D 17 < D 15 < D 13 < D 16 < D 19 < D 12 < D 18$$

As still another example of the reference, the sensory distances may be determined to form an inverted Z shape as illustrated in FIG. 4D. In this case, the sensory distances D11 to D19 of the reference web page W0 between the target web pages W11 to W19 have the following relationship. The inverted Z shape is useful in a language group in which a text is read from right to left.

$$D 17 < D 14 < D 11 < D 12 < D 15 < D 18 < D 19 < D 16 < D 13 or$$

$$D 17 < D 14 < D 11 < D 15 < D 19 < D 16 < D 13 < D 18 < D 12$$

As still another example of the reference, the sensory distances may be determined to form an F shape as illustrated in FIG. 4E. In this case, the sensory distances D11 to D19 of the reference web page W0 between the target web pages W11 to W19 have the following relationship.

$$D 11 < D 14 < D 17 < D 12 < D 15 < D 18 < D 13 < D 16 < D 19 or$$

$$D 11 < D 14 < D 17 < D 12 < D 15 < D 13 < D 18 < D 16 < D 19$$

The inverted N shape, Z shape, inverted Z shape, and F shape described above are merely examples, and any one or more references (rules) that determine the relationship between the positional relationship and the sensory distance in advance may be applied. The user may be able to set via the setter 2 which reference is to be applied to calculate the sensory distance. An example of the method will be described later.

In general, the sensory distance calculator 3 may calculate one or more physical distances by applying one or more references, and add the physical distances with a predetermined weight to obtain a final physical distance. The weight may be determined in advance or may be set by the user via the setter 2. When a physical distance based on a certain reference k is xk and a weight applied to the reference k is wk, a final physical distance 10 is calculated by the following formula.

$$\begin{matrix}[ Math . 1 ] & \\ {l}_{0} = {\sum }_{k} {w}_{k} \cdot {x}_{k} & ( 1 )\end{matrix}$$

For example, it is assumed that k=1 or 2, k=1 indicates the inverted N shape, and k=2 indicates the Z shape. A weight w1=0.3, and a weight w2=0.7. Then, the final physical distance is 10=4.4 (=0.3*3+0.7*5) when a physical distance x1=3 in a case where the inverted N shape is applied, and a physical distance x2=5 in a case where the Z shape is applied.

The sensory distance calculator 3 can calculate a desired physical distance by preparing various references (k=1, 2, . . . ) and appropriately setting the weight wk (setting the weight to 0 for unconsidered references). Although the final physical distance 10 has a linear relationship with respect to each physical distance xk in Formula (1) above, the final physical distance 10 may have a non-linear relationship. The same applies to Formula (2) and the subsequent formulas described later.

The inverted N shape, the Z shape, or the F shape may be applied depending on a layout (configuration) of the reference web page W0. Therefore, the sensory distance calculator 3 may change the weight w in consideration of the layout of the reference web page W0.

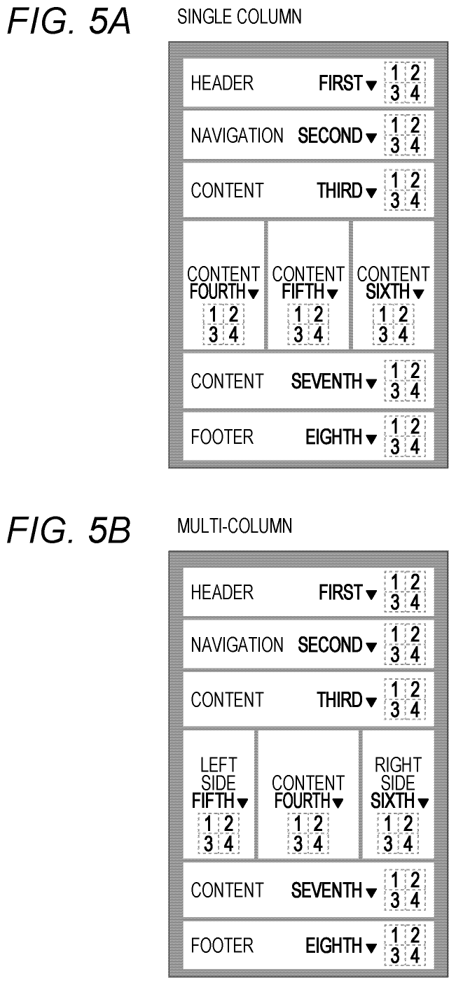

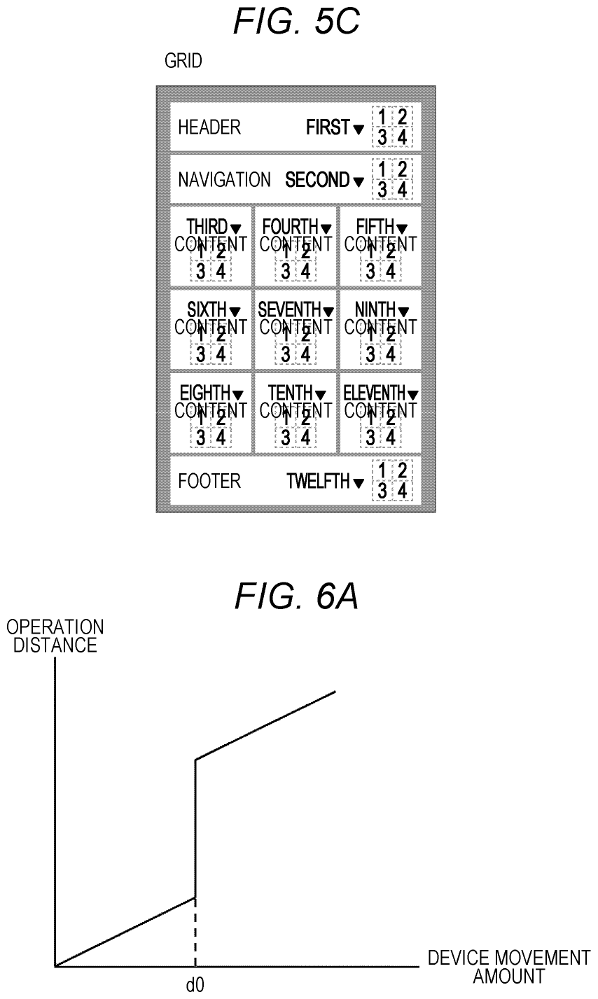

For example, it is assumed that the layout of the reference web page W0 is in a single column format as illustrated in FIG. 5A. In this case, a physical distance to a target web page corresponding to a link arranged in a header part is smaller than a physical distance to a target web page corresponding to a link arranged in another part such as a navigation part. The physical distances are determined to form the Z shape in a case where a plurality of links are arranged in the header part.

The physical distance to the target web page corresponding to the link arranged in the navigation part is the second smallest physical distance following that of the link arranged in the header part. The physical distances are determined to form the Z shape in a case where a plurality of links are arranged in the navigation part.

Hereinafter, the physical distances are determined in the illustrated order. FIG. 5B illustrates a reference in a case where the layout of the reference web page is in a multi-column format, and FIG. 5C illustrates a reference in a case where the layout of the reference web page is in a grid format. The references may be set by the user, and an example of the method will be described later.

The sensory distance calculator 3 may analyze the layout of the reference web page, and apply a reference corresponding to the layout (set the weight).

A relationship between the layout of the reference web page W0 and the weight w may be determined in advance. The relationship between the layout and the appropriate weight w may be learned in advance using a machine learning technique, and the setter 2 may specify the appropriate weight according to the layout of the reference web page W0. The sensory distance calculator 3 may set the weight w according to an actual result of movement of a line of sight of the user measured in advance for each reference web page W0. Such an actual result may be acquired from an external apparatus (not illustrated).

### <Operation Distance>

The sensory distance calculator 3 may calculate the sensory distance in consideration of a user operation required to access the link to the target web page in the reference web page W0, and such a sensory distance is referred to as the “operation distance”.

An amount (which may hereinafter be referred to “device movement amount”) by which the user needs to move an operation device such as a mouse in order to access the link can be applied as a reference for operation distance calculation. A relationship between the device movement amount and the operation distance may be proportional or non-linear. The user may be able to set the relationship via the setter 2.

Examples of the device movement amount include a movement distance of a mouse pointer. In this case, the larger the distance from a predetermined position in the reference web page to the link to the target web page, the larger the sensory distance. The predetermined position may be, for example, a predetermined fixed position (for example, upper left) in the target web page, may be a position corresponding to a position of a link for transitioning to the target web page in a web page before transitioning to the target web page, or may be set by the user via the setter 2.

When the movement distance of the mouse pointer or the like is used to calculate the device movement amount, the relationship with the sensory distance (operation distance) may be proportional or non-linear. This is because, for example, there is a case where a movement distance of the thumb and the sensory distance are not proportional to each other in a case of considering a value corresponding to the movement distance of the mouse pointer as the movement distance of the thumb operating a touch panel when a smartphone is held with one hand and operated with the thumb of the hand holding the smartphone.

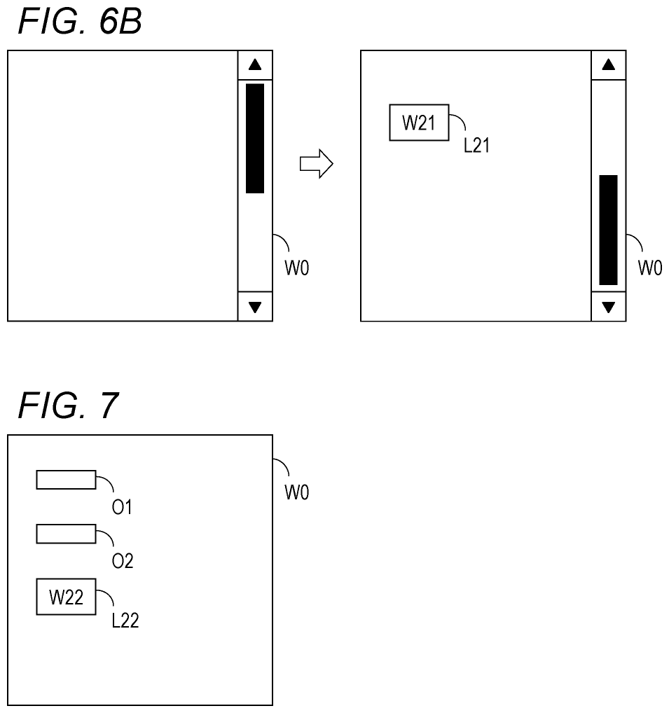

Specifically, as large as a distance that can be reached without changing the hand holding the smartphone is equal to or less than a distance do, the device movement amount and the operation distance may be proportional to each other in the range (FIG. 6A). On the other hand, in a case of a distance that cannot be reached unless the hand holding the smartphone is changed (that is, a distance larger than d0), an operation of changing the hand holding the smartphone occurs even when the device movement amount is small, and thus, it is considered that the movement distance (device movement amount) of the mouse pointer and the sensory distance (operation distance) greatly deviate from the proportional relationship. The above-described example may be approximately handled by establishing any non-linear correspondence between the movement distance and the sensory distance.

Another example of the device movement amount is a scroll distance. For example, the larger the scroll amount is (the lower the link L22 is positioned), the larger the sensory distance is in a case where a link L21 to a target web page W21 is not displayed at an upper part of the reference web page W0 (a state when the reference web page W0 is displayed), and the link L21 appears by scrolling downward (specific examples include a case where a scroll bar is moved using a touch panel or a mouse and a case where a mouse wheel is rotated) as illustrated in FIG. 6B.

The scrolling includes horizontal scrolling in addition to the vertical scrolling illustrated in FIG. 6B. The sensory distance calculator 3 may or does not have to equally evaluate the scroll amount in the vertical scrolling and the scroll amount in the horizontal scrolling to calculate the operation distance. For example, in a case where the operation device is a mouse, generally, the vertical scrolling can be easily performed with a mouse wheel. Therefore, in a case where the scroll amount in the vertical scrolling is equal to the scroll amount in the horizontal scrolling, the sensory distance calculator 3 desirably increases the operation distance of the latter.

The number of operations (which may hereinafter be referred to as “the number of device operations”) for the operation device required to transition to the target web page can be applied as another reference for operation distance calculation. A relationship between the number of device operations and the operation distance may be proportional or non-linear. The user may be able to set the relationship via the setter 2. The operation distance in a case where the operation is clicking can also be referred to as a click distance.

An example of the number of device operations is the number of key presses on the keyboard as the operation device, required to transition to the target web page.

For example, it is assumed that the reference web page W0 contains objects (such as text and images) O1 and O2 and a link L22 to the target web page W22 as illustrated in FIG. 7. Then, the object O1 is selected when a tab key of the keyboard is pressed once in a state in which the reference web page W0 is displayed, then the object O2 is selected when the tab key is pressed once, and then the link L22 is selected when the tab key is pressed once. When the Enter key is pressed in a state in which the link L22 is selected, the target web page W22 is displayed.

In this case, the sensory distance calculator 3 calculates the operation distance based on the fact that the tab key needs to be pressed three times (the number of device operations is three).

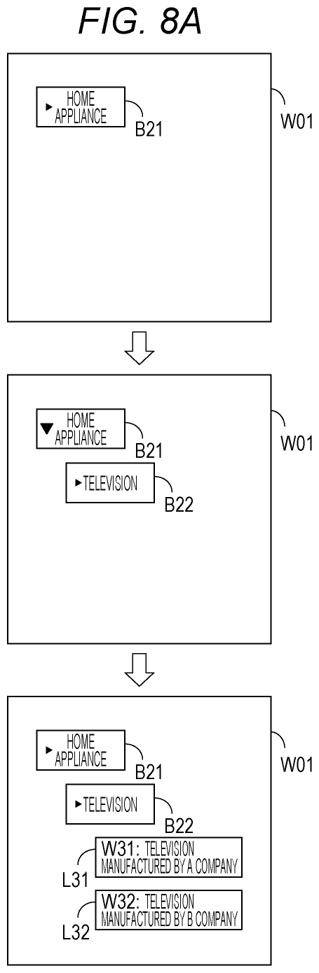

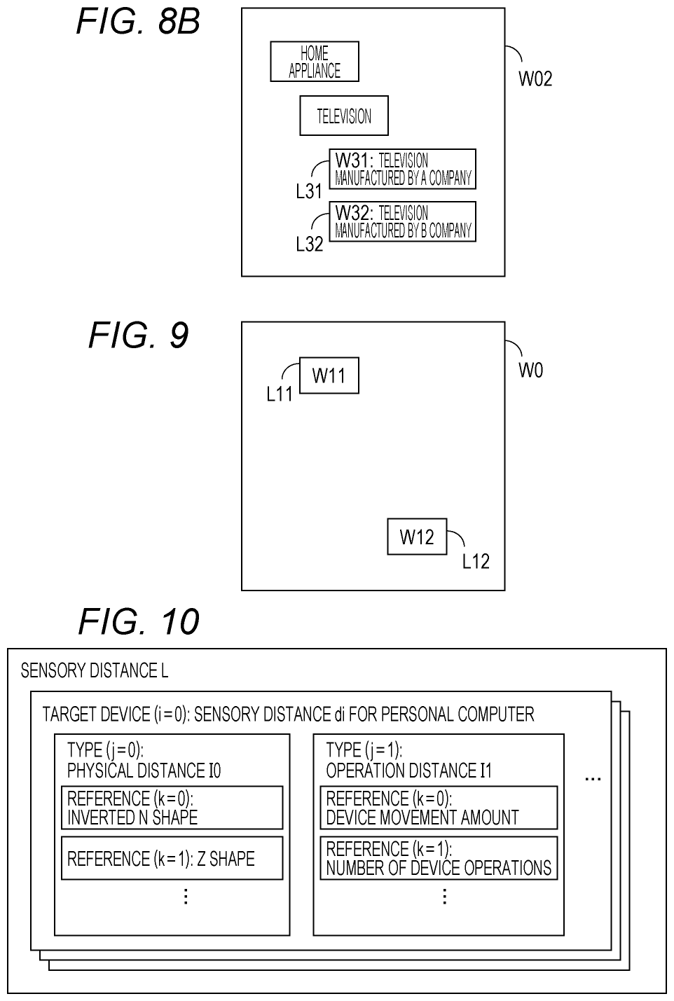

Another example of the number of device operations will be described. It is assumed that, in a reference web page W01 illustrated in FIG. 8A, a button B22 labeled “television” appears when a button B21 labeled “home appliance” and contained in the reference web page W01 is selected (for example, a user operation such as touching or clicking), and a link L31 to a target web page W31 related to “television manufactured by A company” and a link L32 to a target web page W32 related to “television manufactured by B company” appear when the button B22 is selected. That is, two user operations are required after the reference web page W01 is displayed in order to expand the button B21 and the button B22 and display the links L31 and L32.

On the other hand, the links L31 and L32 are displayed in advance in a reference web page W02 illustrated in FIG. 8B. That is, a further user operation is unnecessary after the reference web page W02 is displayed in order to display the links L31 and L32.

In this case, the sensory distance calculator 3 may make an operation distance D11 from the reference web page W01 to the target web page W31 larger than an operation distance D12 from the reference web page W02 to the target web page W31 (D12<D11). This is because the former requires more user operations.

A reference web page W03 having a configuration in which the button B21 is arranged similarly to the reference web page W01 illustrated in FIG. 8A, but the button B22 appears when a mouse cursor is placed on the button B21 (without performing selection such as clicking), and the links L31 and L32 appear when the mouse cursor is placed on the button B22 (without performing selection such as clicking) is also conceivable. In this case, the sensory distance calculator 3 may set an operation distance D13 from the reference web page W03 to the target web page W31 in such a way that D12<D13<D11. This is because, in a case where the reference web page is W03, more user operations are required to display the link L31 as compared with the reference web page W02 that does not require a further user operation, but the user operations are less required as compared with the reference web page W01 that requires selection (clicking or the like) of the buttons B21 and B22.

Another example of the number of device operations includes the number of input characters required to transition from the reference web page W0 to the target web page.

In general, the sensory distance calculator 3 may calculate the operation distance by applying one or more references, and add the operation distances with a predetermined weight to obtain a final operation distance. The weight may be determined in advance or may be set by the user. When an operation distance based on a certain reference k (for example, k=0: the device movement amount, k=1: the number of device operations) is xk and a weight applied thereto is wk, a final operation distance 11 is calculated by the following formula.

$$\begin{matrix}[ Math . 2 ] & \\ {l}_{1} = {\sum }_{k} {w}_{k} \cdot {x}_{k} & ( 2 )\end{matrix}$$

For example, it is assumed that k=1 or 2, k=1 indicates the device movement amount, and k=2 indicates the number of device operations. A weight w1=0.3, and a weight w2=0.7. Then, the final operation distance is 11=4.4 (=0.3*3+0.7*5) when an operation distance x1=3 in a case where the device movement amount is applied, and an operation distance x2=5 in a case where the number of device operations is applied.

The sensory distance calculator 3 can calculate a desired operation distance by preparing various references (k=1, 2, . . . ) and appropriately setting the weight wk (setting the weight to 0 for unconsidered references).

### <Link Path Distance>

The sensory distance calculator 3 may calculate the sensory distance based on the number of link selections (clicks or the like) (for example, the number of selections in the smallest path) required to transition from the reference web page W0 to the target web page, and such a sensory distance is referred to as the “link path distance”.

For example, in a case where a link in the reference web page is selected to transition to another web page, and a link in the another web page is selected to transition to the target web page, the link path distance is 2.

### <Perceived Distance>

The sensory distance calculator 3 may calculate the sensory distance based on the ease of link perception for the user, and such a sensory distance is referred to as the “perceived distance”.

The size, thickness, color, position, and text font of a link (or a character in a link, the same applies to the following) can be exemplified as a reference for perceived distance calculation. Specifically, for example, the larger the character in the link, the thicker the character in the link, or the darker the character in the link, the smaller the sensory distance may be. The color of the link as the reference may be the color of the link itself or a difference between the link and the background (a luminance difference, a hue difference, a saturation difference, or a distance in an arbitrary color space (for example, L*a*b*space)).

A predetermined rule (a rule determined in advance or a rule set by the user via the setter 2) may be applied to a relationship between the sensory distance and the color. For example, a sensory distance to a target web page associated with a link whose character color is red may be small, and a sensory distance to a target web page associated with a link whose character color is blue may be large. The same applies to the font.

In general, the sensory distance calculator 3 may calculate the perceived distance by applying one or more references, and add the perceived distances with a predetermined weight to obtain a final perceived distance. The weight may be determined in advance or may be set by the user. Specifically, when a perceived distance based on a certain reference k (k=0: size, k=1: thickness, k=2: color, k=3: position, k=4: text font, or the like) is xk and a weight applied thereto is wk, a final perceived distance 12 is calculated by the following formula.

$$\begin{matrix}[ Math . 3 ] & \\ {l}_{2} = {\sum }_{k} {w}_{k} \cdot {x}_{k} & ( 3 )\end{matrix}$$

The perceived distance can vary depending on an attribute of the user (for example, age, sex, or a patient's illness). Therefore, the weight w may vary depending on a target user.

### <Temporal Distance>

The sensory distance calculator 3 may calculate the sensory distance in consideration of a time required to display the target web page, and such a sensory distance is referred to as the “temporal distance”.

A time taken to become accessible to a link is exemplified as a reference for temporal distance calculation. For example, in a case where a link appears (or becomes selectable) in the reference web page W0 after display of an animation moving image is finished, the sensory distance calculator 3 may increase the temporal distance to the target web page associated with the link. The sensory distance calculator 3 may increase the temporal distance as a load time for the reference web page is larger. Such a time can be grasped by analyzing the reference web page W0.

The sensory distance may be calculated in consideration of a time from when the user performs an operation (for example, clicking a mouse or touching a touch panel) for transitioning from the reference web page W0 to the target web page on the operation device to when the target web page is displayed (appears) as another reference for temporal distance calculation. Such a time is a time from when a web browser reads the target web page to when the target web page is displayed, and can be measured by the web browser. The sensory distance calculator 3 may acquire information regarding the time until the target web page is displayed from the web browser or the like, if necessary.

### <User Action Distance>

The sensory distance calculator 3 may calculate the sensory distance in consideration of actual results (actions of users) of transition from the reference web page W0 to the target web page, and such a sensory distance is referred to as a “user behavior distance”.

For example, in a case where there are many users who have transitioned from the reference web page W0 to a target web page W1 but there are few users who have transitioned from the reference web page W0 to a target web page W2, a sensory distance from the reference web page W0 to the target web page W1 is smaller than a sensory distance from the reference web page W0 to the target web page W2.

It is possible to easily grasp a result of transition from which web page to which web page by using an existing technology (access analysis tool or the like). The sensory distance calculator 3 may acquire information regarding actual results from the access analysis tool or the like, if necessary.

### <Other Sensory Distances>

Transition from the reference web page W0 to the target web page is not necessarily limited to link selection. For example, transition from the reference web page W0 to the target web page can be made by a speech, a gesture, a line of sight, and the like. In this case, the sensory distance calculator 3 may calculate the sensory distance in consideration of such transitions. As an example, in a case where transition by one click is set as a sensory distance of 1, transition by a speech is set as a sensory distance of 0.9.

### <Device-Dependent Sensory Distance>

The sensory distance calculator 3 may calculate the sensory distance based on a target device on which the reference web page W0 is displayed. For example, the reference web page W0 contains a link L11 to a target web page W11 arranged on the upper left side and a link L12 to a target web page W12 arranged on the lower right side as illustrated in FIG. 9.

It is considered that the user more easily clicks the link L11 provided on the upper left side in a case where the target device is a personal computer and the reference web page is displayed on a display of the personal computer or an external display connected to the personal computer. Therefore, in this case, the sensory distance calculator 3 makes a sensory distance from the reference web page W0 to the target web page W11 smaller than a sensory distance from the reference web page W0 to the target web page W12.

On the other hand, in a case where the target device is a smartphone and the reference web page W0 is displayed on a touch panel display of the smartphone, many users hold a smartphone with the right hand, and thus it is considered that the link L12 is easier to click. Therefore, in this case, the sensory distance calculator 3 makes the sensory distance from the reference web page W0 to the target web page W11 larger than the sensory distance from the reference web page W0 to the target web page W12.

In addition, a display region or display size varies depending on a device on which the reference web page W0 is displayed. For example, a relatively large device such as a personal computer displays a large region in the reference web page. On the other hand, a relatively small device such as a smartphone displays only a small region of the reference web page. Therefore, the sensory distance calculator 3 may calculate the sensory distance in consideration of a region in which the reference web page W0 is displayed and/or the size of the device on which the reference web page is displayed.

### <Sensory Distance Calculation>

As described above, the sensory distance calculator 3 can calculate various types of sensory distances based on various references. The sensory distance calculator 3 may calculate one or more types of sensory distances described above based on one or more references, and may comprehensively add the sensory distances to calculate the final sensory distance.

The concept of the sensory distance calculation is illustrated in FIG. 10.

A final sensory distance L (first sensory distance) can be obtained by adding sensory distances di (second and third sensory distances) for one or more target devices i with a predetermined weight wi. That is, the final sensory distance L is calculated by the following formula. For example, i=0: the target device is a personal computer, and i=1: the target device is a smartphone.

$$\begin{matrix}[ Math . 4 ] & \\ L = {\sum }_{i} {w}_{i} \cdot {d}_{i} & ( 4 )\end{matrix}$$

The sensory distance di for the target device i can be obtained by adding sensory distances lij (second and third sensory distances) of a type j with a predetermined weight wij. That is, the sensory distance di for the target device i is calculated by the following formula. For example, j=0: physical distance, and j=1: operation distance.

$$\begin{matrix}[ Math . 5 ] & \\ {d}_{i} = {\sum }_{j} {w}_{ij} \cdot {l}_{ij} & ( 5 )\end{matrix}$$

The sensory distance lij of the type j for the target device i can be obtained by adding sensory distances xijk (second and third sensory distances) in a case where the reference k is applied, with a predetermined weight wijk.

That is, the sensory distance lij of the type j for the target device i is calculated by the following formula. For example, in a case where j=0 (physical distance), k=0: inverted N shape, and k=1: Z shape.

$$\begin{matrix}[ Math . 6 ] & \\ {l}_{ij} = {\sum }_{k} {w}_{ijk} \cdot {x}_{ijk} & ( 6 )\end{matrix}$$

It is possible to adjust the type of the sensory distance to be calculated and the reference to be applied by appropriately setting the weight w in the general formulas (4) to (6) described above. The weight w may be determined in advance or may be set by the user via the setter 2. The sensory distance setter 2 may dynamically set the weight w based on the reference web page W0.

In the present embodiment, a directory distance between the reference web page W0 and the target web page (the number of levels in the directory structure) is not set as the sensory distance. However, it is possible to set the directory distance as a type of sensory distance and calculate the sensory distance in combination with other types of sensory distances. In this case, the directory distance may be set to 0 or 2, or may be set by the user when the reference web page W0 and the target web page are in the same level.

In the present embodiment, a semantic distance itself between the reference web page W0 and the target web page (how close the contents of the two web pages are) is not set as the sensory distance. However, it is possible to set the semantic distance as a type of sensory distance and calculate the sensory distance in combination with other types of sensory distances. The sensory distance calculator 3 calculates the semantic distance by applying a known method. As an example, the sensory distance setter 2 may execute natural language processing to calculate the semantic distance, and specifically, may calculate the semantic distance based on a distance between a multidimensional feature vector based on the content of the reference web page and a multidimensional feature vector based on the content of the target web page (see JP 6680956 B2).

### <Processing Operation of Site Map Generation Apparatus>

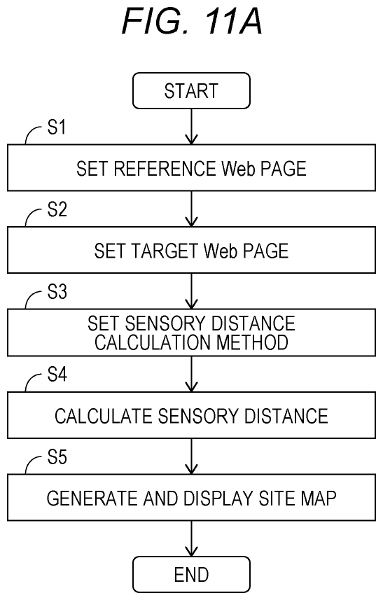

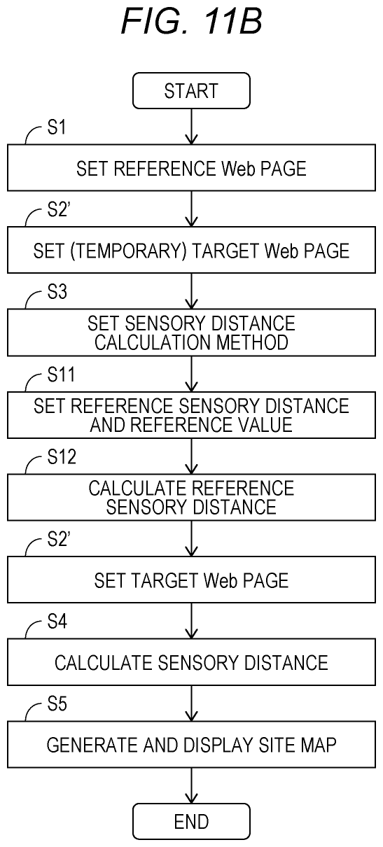

FIG. 11A is a flowchart illustrating an example of a processing operation of the site map generation apparatus.

The setter 2 sets the reference web page by receiving an input of the reference web page from the user (step S1). The setter 2 sets the target web page by receiving an input of the target web page from the user (step S2). Then, the setter 2 sets a sensory distance calculation method by receiving an input of the sensory distance calculation method from the user (step S3). The order of steps S1 to S3 may be appropriately changed.

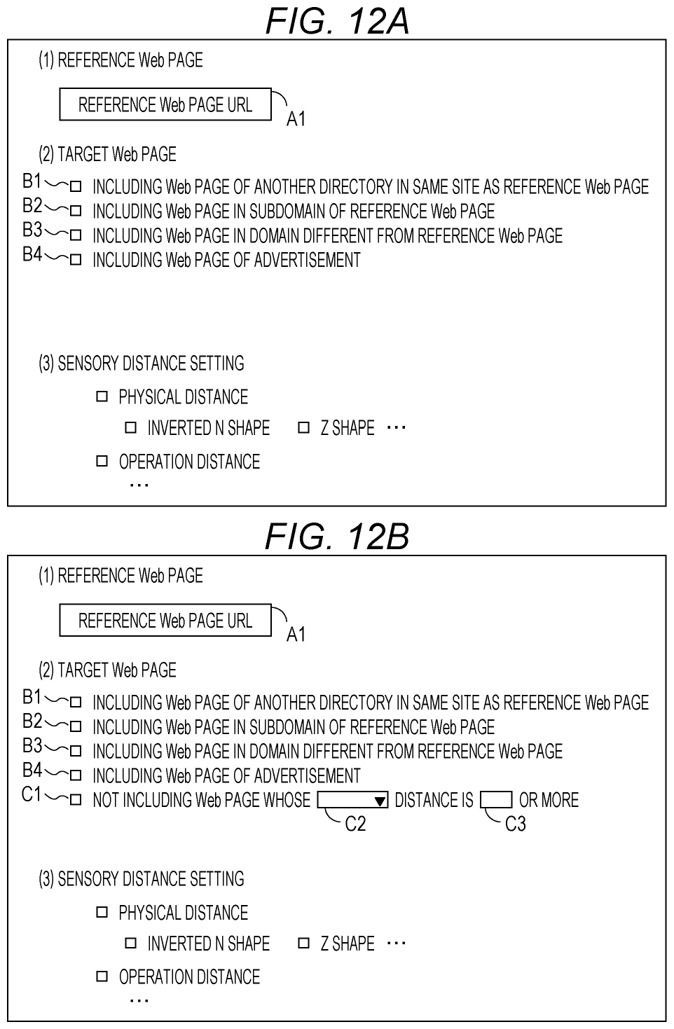

The setter 2 causes the display 6 to display a screen as illustrated in FIG. 12A for these settings.

The user inputs an URL of a web page to be set as the reference web page in a reference web page URL input field A1. The setter 2 sets the reference web page according to the input.

The user checks a check box associated with a web page to be set as the target web page. The setter 2 sets the target web page according to the check result.

In a case where none of the check boxes is checked, the setter 2 sets, as the target web page, only a web page of a lower level directory in the same site (that is, having the same domain) as the reference web page. The setter 2 also sets a web page in another directory in the same site as the reference web page as the target web page in a case where a check box B1 is checked. The setter 2 also sets a web page in a subdomain of the reference web page as the target web page in a case where a check box B2 is checked. The setter 2 also sets a web page in a domain different from the reference web page as the target web page in a case where a check box B3 is checked. The setter 2 also sets a web page of an advertisement as the target web page in a case where a check box B4 is checked.

The user checks a check box associated with an item (a type or reference) to be considered when calculating the sensory distance. The setter 2 sets the sensory distance calculation method according to the check result. The setting of the sensory distance calculation method is, for example, setting of the weights in Formulas (4) to (6) described above.

Returning to FIG. 11A, the sensory distance calculator 3 calculates the sensory distance from the reference web page to the target web page based on the settings in steps S1 to S3 (step S4). Then, the site map generator 4 generates a site map based on the calculated sensory distance, and the output controller 5 displays the site map on the display 6 (step S5).

In a case where the user determines that there is a problem in the displayed site map (for example, the site map greatly deviates from intuition), the sensory distance calculation method may be reset (step S3), and the site map generation may be performed again.

In the processing of FIG. 11A, the sensory distance is calculated for all the target web pages set in step S2 of FIG. 11A and FIG. 12A. However, when a web page that is hardly recognized even if the web page is contained in the target web pages is set as a target of the sensory distance calculation, a sensory distance to the web page can be a less meaningful sensory distance.

Therefore, the sensory distance may be calculated excluding a less meaningful target web page before calculating the sensory distance. As an example of a specific method therefor, a sensory distance as a reference (for example, the perceived distance) may be determined, and the sensory distance may be calculated only for a target web page for which the sensory distance satisfies a predetermined condition (for example, smaller than a reference value). A specific description will be given below.

FIG. 11B is a flowchart illustrating another example of the processing operation of the site map generation apparatus. FIG. 12B is a diagram illustrating another example of the screen displayed on the display by the setter 2. In FIGS. 11B and 12B, processings common to those in FIGS. 11A and 12A are denoted by common reference numerals.

The setter 2 sets the reference web page, the target web page, and the sensory distance calculation method by using the screen illustrated in FIG. 12B (Steps S1, S2′, and S3). Further, the setter 2 sets a reference sensory distance (fourth sensory distance) and a reference value (predetermined condition) (step S11).

The target web page set in step S2′ is a temporary target web page (third electronic medium). For example, the temporary target web page is set according to whether or not each of check boxes B1 to B4 is checked in FIG. 12B (similarly to step S2 in FIG. 11A).

The user checks the check box C1 in FIG. 12B in a case where the user desires to exclude a less meaningful sensory distance. In addition, the user sets a sensory distance as a reference (reference sensory distance) in a reference sensory distance setting field C2, and sets a threshold in a reference value setting field C3. The reference sensory distance may be any of the above-described sensory distances, and is, for example, the perceived distance. As described above, the setter 2 sets the reference sensory distance and the reference value. The reference sensory distance and/or the reference value may be determined in advance instead of being set by the user.

Subsequently, the sensory distance calculator 3 calculates the reference sensory distance from the reference web page to the temporary target web page (step S12). Then, the setter 2 sets, as the target web page, a temporary target web page whose reference sensory distance is smaller than the reference value among the temporary web pages (step S2). In other words, the setter 2 excludes, from the target web page, a temporary target web page whose reference sensory distance is equal to or larger than the reference value among the temporary target web pages.

Then, the sensory distance calculator 3 calculates the sensory distance for the target web page set in step S2 (step S4). In other words, in step S4, the sensory distance is not calculated for a temporary target web page whose reference sensory distance is equal to or larger than the reference value among the temporary target web pages.

In this manner, a link to a web page whose reference sensory distance is equal to or larger than the reference value can be regarded as an invalid link and can be excluded from the target web page. As a result, it is possible to calculate the sensory distance more suitable for the actual situation. In addition, the number of target web pages for which the sensory distance is to be calculated can be reduced, and the processing in the sensory distance calculator 3 can be reduced.

### <Specific Example of Site Map>

The site map generator 4 generates a site map (sensory distance information) indicating a relationship between the reference web page W0 and the target web page based on the sensory distance between the reference web page W0 and the target web page. The generated site map is displayed on the display 6 or printed. As a result, the relationship between the reference web page W0 and the target web page is visualized. The relationship between the reference web page W0 and the target web page can be intuitively grasped in a short time by being visualized on the display 6. Therefore, a time for displaying the site map on the display 6 can be shortened, and power consumption of the display 6 can be reduced.

As an example, the site map to be displayed or printed may contain some or all of a node (symbol) corresponding to the reference web page W0, a node (symbol) corresponding to the target web page, and an edge (path) connecting the nodes.

The relationship between the reference web page and the target web page visualized on the site map may be one or two or more of the final sensory distance (the sensory distance L in Formula (4) above), the sensory distance for the specific target device i (the distance di in Formula (5) above), the sensory distance for the specific target device i and the specific type j (the distance lij in Formula (6) above), the sensory distance for the specific target device i, the specific type j, and the specific reference k (xijk in Formula (6) above). In a case of two or more, one of them may be the semantic distance or the directory distance between the reference web page and the target web page.

Furthermore, such a relationship can be indicated by elements such as a display position (an x coordinate and/or a y coordinate, and a z coordinate in a case of three-dimensional display) and a display aspect of a node. The display aspect is, for example, the size of a node, the thickness of an edge, the color (brightness, saturation, transparency, hue, or the like) of a node and/or edge, a pattern (for example, nodes corresponding to target web pages whose sensory distance from the reference web page is within a predetermined distance are displayed in the same pattern), or animation display (blinking at a speed corresponding to the sensory distance, an increase or reduction in scale, or the like).

What kind of relationship is represented by which element may be determined in advance, or may be settable by the user via the setter 2.

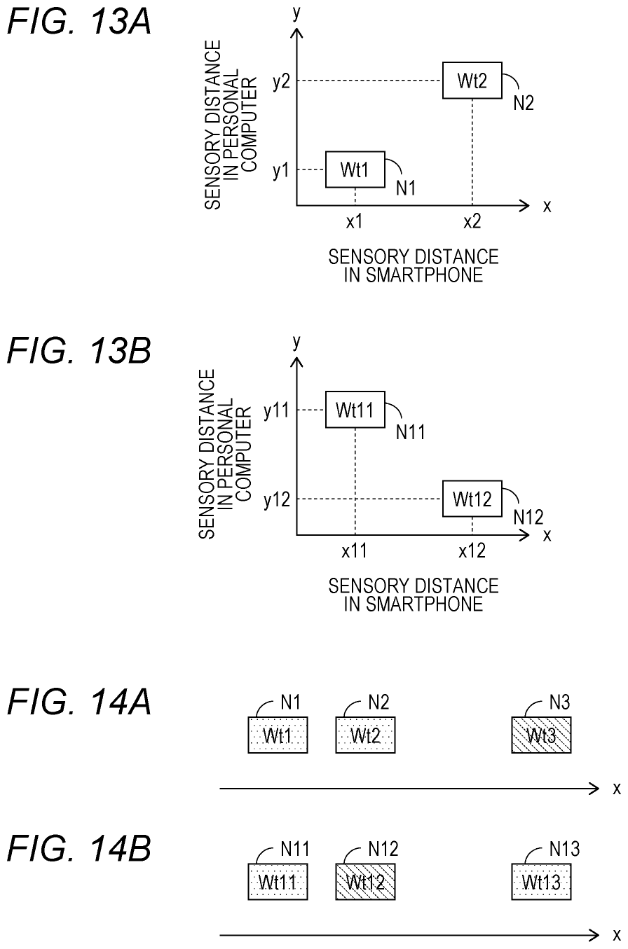

FIGS. 13A and 13B are schematic diagrams illustrating an example of the site map. In both of FIGS. 13A and 13B, the horizontal axis (x axis) represents a sensory distance from the reference web page W0 in a smartphone, and the vertical axis (y axis) represents a sensory distance from the reference web page W0 in a personal computer. That is, an example is illustrated in which information such as the sensory distance in the smartphone and the sensory distance in the personal computer is represented by an element such as the display position (x coordinate and y coordinate) of a node.

An arrangement position of a node N1 (corresponding to a target web page Wt1) in FIG. 13A means that a sensory distance between the reference web page W0 and the target web page Wt1 in the smartphone is x1, and the sensory distance in the personal computer is y1. Similarly, an arrangement position of a node N2 (corresponding to a target web page Wt2) means that a sensory distance between the reference web page W0 and the target web page Wt2 in the smartphone is x2, and the sensory distance in the personal computer is y2.

Referring to FIG. 13A, since x1<x2 and y1<y2, it can be seen that the sensory distances of the target web pages Wt1 and Wt2 with respect to the reference web page W0 do not depend much on the device (whether it is a smartphone or a personal computer).

An arrangement position of a node N11 (corresponding to a target web page Wt11) in FIG. 13B means that a sensory distance between the reference web page W0 and the target web page Wt11 in the smartphone is x11, and the sensory distance in the personal computer is y11. Similarly, an arrangement position of a node N12 (corresponding to a target web page Wt12) means that a sensory distance between the reference web page W0 and the target web page Wt12 in the smartphone is x12, and the sensory distance in the personal computer is y12.

Referring to FIG. 13B, since x11<x12 and y11>y12, it can be seen that the sensory distances of the target web pages Wt11 and Wt12 with respect to the reference web page W0 vary depending on the device (whether it is a smartphone or a personal computer).

In this way, it is possible to verify whether or not there is a gap between the sensory distances depending on the device. It can be said that the closer the relationship between x and y is to proportional, the smaller the gap depending on the device.

FIGS. 14A and 14B are schematic diagrams illustrating another example of the site map. In both of FIGS. 14A and 14B, the horizontal axis (x axis) represents the link path distance with respect to the reference web page W0, and the hue represents the semantic distance with respect to the reference web page W0. For convenience, it is assumed that a dot pattern (nodes N1, N2, N11, and N13) in FIGS. 14A and 14B is a certain hue and has a meaning similar to that of the reference web page W0. A diagonal line pattern (node N3, and N12) is another hue, and has a meaning different from that of the reference web page W0.

Referring to FIG. 14A, the nodes N1 and N2 respectively corresponding to the target web pages Wtl and Wt2 having a meaning similar to that of the reference web page W0 are arranged close to each other in a region where the value of x is small. On the other hand, the node N3 corresponding to a target web page Wt3 having a meaning different from that of the reference web page W0 is arranged away from the nodes N1 and N2 in a region where the value of x is large.

Referring to FIG. 14A, the target web pages Wtl and Wt2 having a meaning similar to that of the reference web page W0 have small link path distances, and the target web page Wt3 having a different meaning has a large link path distance in the reference web page W0.

Referring to FIG. 14B, the node N11 corresponding to the target web page Wt11 having a meaning similar to that of the reference web page W0 is arranged in a region where the value of x is small, but the node N13 corresponding to the target web page Wt12 having a meaning similar to that of the reference web page W0 is arranged in a region where the value of x is large. In addition, the node N12 corresponding to the target web page Wt12 having a meaning different from that of the reference web page W0 is arranged close to the node N11 in a region where the value of x is small.

Referring to FIG. 14B, it can be seen that the target web page Wt13 has a meaning similar to that of the reference web page W0, but the link path distance is large in the reference web page W0. In addition, it can be seen that the target web page Wt12 has a meaning different from the reference web page W0, but the link path distance is shortened in the reference web page W0.

In this manner, it is possible to verify whether or not a target web page having a meaning similar to that of the reference web page W0 has a small link path distance.

In FIGS. 14A and 14B, the horizontal axis may represent the perceived distance. As a result, it is possible to verify whether or not a target web page having a meaning similar to that of the reference web page W0 is easily perceived.

In this manner, the sensory distance calculator 3 calculates the sensory distance and the semantic distance, whereby the relationship between the two can be grasped. The output controller 5 may issue an alert in a case where the sensory distance and the semantic distance have a predetermined relationship. The predetermined relationship is, for example, a case where the semantic distance between the reference web page and the target web page is equal to or smaller than a predetermined value (similar in meaning) but the sensory distance between the reference web page and the target web page is equal to or larger than a predetermined value (sensorially distant), or conversely, a case where the semantic distance is equal to or larger than the predetermined value (different in meaning) but the sensory distance between the reference web page and the target web page is equal to or larger than the predetermined value (sensorially close).

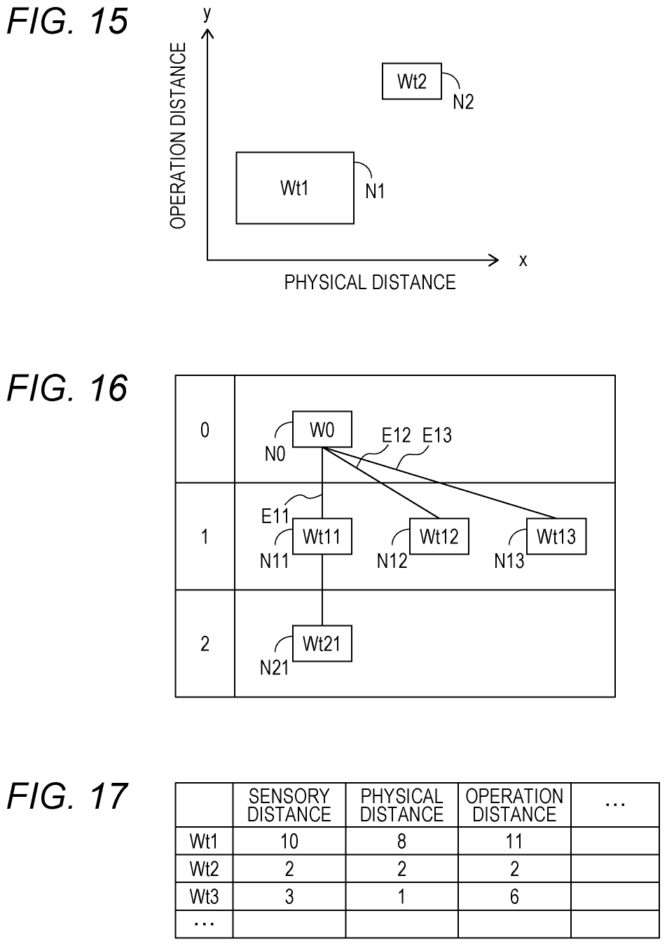

FIG. 15 is a schematic diagram illustrating another example of the site map. The horizontal axis represents the physical distance to the reference web page W0, and the vertical axis represents the operation distance to the reference web page W0. The size of the node represents the perceived distance, and the larger the size, the smaller the perceived distance. In this manner, different types of sensory distances may be indicated by different elements in the site map. In addition, a plurality of sensory distances of the same type may be calculated with different weights for the reference, and may be indicated by a plurality of elements in the site map.

FIG. 16 is a schematic diagram illustrating another example of the site map. The site map contains a node NO corresponding to the reference web page W0 and nodes N11 to N13 and N21 respectively corresponding to target web pages Wt11 to Wt13 and Wt21.

The vertical axis (y axis) in the site map corresponds to the click distance required to reach each of the target web pages from the reference web page W0. For example, the number of clicks required to reach the target web pages Wt11 to Wt13 from the reference web page W0 is one, and the number of clicks required to reach the target web page Wt21 from the reference web page W0 is two.

The horizontal axis (x axis) corresponds to the sensory distance from the reference web page W0 to each of the target web pages. For example, a relationship between sensory distances L11 to L13 between the reference web page W0 and the target web pages Wt11 to Wt13 is L11<L12<L13.

The length of an edge path provided between two nodes corresponds to a sensory distance between web pages corresponding to the nodes. For example, an edge E11 provided between the node NO and the node N11 corresponds to the sensory distance L11 between the reference web page W0 and the target web page Wt11. The term “correspond” does not necessarily mean that the length of the edge and the sensory distance need to be in one-to-one correspondence (for example, proportional), and may mean that a magnitude relationship between a plurality of sensory distances can be grasped.

The user may make various settings in the site map as described above. For example, it may be possible to set whether or not to display an URL of a corresponding web page, various tags such as title, meta keywords, meta description, and h1 in an HTML file, a linked anchor, and a linked alt in the node. Furthermore, it may be possible to display what kind of meaning the corresponding web page has at what ratio (see JP 6680956 B2) in the node. In addition, the user may be able to set the color or aspect of the edge. The edge may be displayed in a shape corresponding to whether the web pages are in a unidirectional link or bidirectional link.

FIG. 17 is a schematic diagram illustrating another example of the site map. The site map may be displayed in a table (list) format as illustrated in FIG. 17. In FIG. 17, the target web pages Wt1 to Wt3 are displayed as nodes, and the final sensory distance, physical distance, and operation distance are shown in association with each other. In a case of outputting the site map in the table format, it is desirable that the output controller 5 can sort the target web pages in order of the sensory distance.

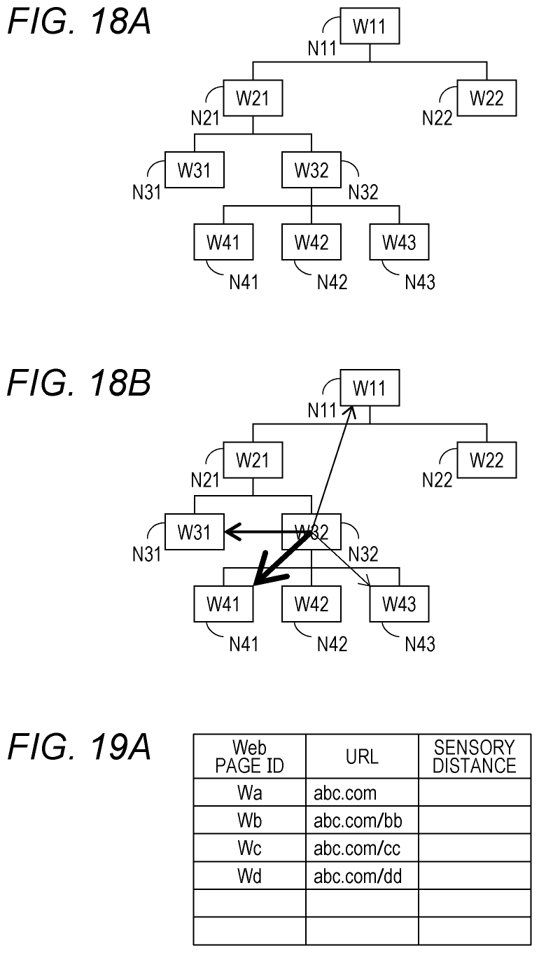

FIGS. 18A and 18B are schematic diagrams illustrating another example of the site map. The output controller 5 displays a directory structure of a plurality of web pages as illustrated in FIG. 18A. Each node Ni corresponds to each web page Wi. The sensory distance is unknown in the site map based on the directory structure as described with reference to FIG. 2A.

The user can select any node (that is, any web page). As a result, the setter 2 sets the selected web page as the reference web page, and sets the other web pages as the target web pages. Here, it is assumed that a node N32 (web page W32) is selected.

Then, the site map generator 4 generates an edge to another node starting from the node N32 as illustrated in FIG. 18B. A display aspect (for example, the thickness) of the edge corresponds to the sensory distance.

For example, an edge from the node N32 to a node N41 is thick. Therefore, it can be seen that a sensory distance between a web page W32 and a web page W41 one level below the web page W32 is small. On the other hand, an edge from the node N32 to a node N43 is thin. Therefore, it can be seen that a web page W43 is only one level below the web page W32, but a sensory distance between the web page W43 and a web page W32 is large.

The site map generator 4 may generate an edge between the node corresponding to the reference web page and the nodes corresponding to all the other target web pages, may generate an edge only between the nodes corresponding to the target web pages whose sensory distance is equal to or smaller than a threshold, or may generate a predetermined number of edges in ascending order of the sensory distance. The threshold and the predetermined number may be determined in advance or may be set by the user.

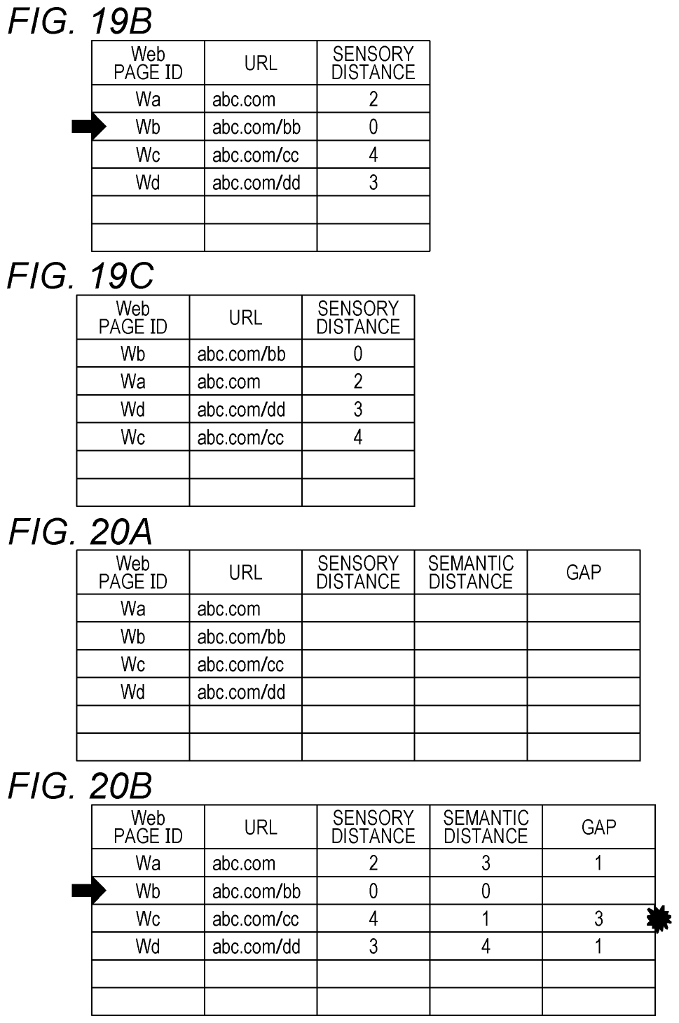

FIGS. 19A to 19C are diagrams for describing an example of a processing operation of the site map generation apparatus, and may be combined with any embodiment described above as large as there is no contradiction.

The output controller 5 causes the display 6 to display information indicating a plurality of web pages as illustrated in FIG. 19A. As an example, the information indicating the web pages may be IDs of the web pages and URLs of the web pages. In addition, a display format of the information may be a table format. FIG. 19A illustrates, as the plurality of web pages, a web page (web page Wa) having a URL including “abc.com” and web pages one level below the web page, but there is no particular limitation, and the output controller 5 may display information of an arbitrary web page.

Although there is a field for displaying the sensory distance in the table illustrated in FIG. 19A, which web page is to be set as the reference web page has not been determined, and thus, the sensory distance is not displayed in this state.

The user selects a web page to be set as the reference web page via the input interface 1. For example, it is assumed that the web page Wb is selected as illustrated in FIG. 19B. In this case, the setter 2 sets the selected web page Wb as the reference web page, and sets the other web pages Wa, Wc, and Wd as the target web pages. The setter 2 may set only some of the other web pages Wa, Wc, and Wd (for example, those whose directory distance is equal to or smaller than a predetermined value) as the target web pages.

Then, the sensory distance calculator 3 calculates sensory distances between the reference web page Wb and the other target web pages Wa, Wc, and Wd. Further, the output controller 5 displays the calculated sensory distance in association with each target web page. Specifically, the output controller 5 displays the calculated sensory distance in the field for displaying the sensory distance in the table illustrated in FIG. 19B. In FIG. 19B, for example, the sensory distance between the reference web page Wb and the target web page Wa is “2”. The sensory distance of the reference web page Wb may be “0” as illustrated, may be “-” (hyphen), or does not have to be displayed. In any case, it is desirable to be able to recognize which web page is the reference web page.

Here, in a case where the user issues a predetermined sorting instruction (for example, a column or a title part for displaying the sensory distance is selected), the output controller 5 sorts the target web pages Wa, Wc, and Wd in the order of the sensory distances as illustrated in FIG. 19C. The sorting order may be either the ascending order of the sensory distance or a descending order of the sensory distance.

FIGS. 20A and 20B are diagrams for describing another example of the processing operation of the site map generation apparatus, and may be combined with any embodiment described above as large as there is no contradiction.

Similarly to FIG. 19A, the output controller 5 causes the display 6 to display information indicating a plurality of web pages as illustrated in FIG. 20A. Although there are fields for displaying the sensory distance and the semantic distance in the table illustrated in FIG. 20A, which web page is to be set as the reference web page has not been determined, and thus, the sensory distance and the semantic distance are not displayed in this state.

The user selects a web page to be set as the reference web page via the input interface 1. For example, it is assumed that the web page Wb is selected as illustrated in FIG. 20B. In this case, the setter 2 sets the selected web page Wb as the reference web page, and sets the other web pages Wa, Wc, and Wd as the target web pages. The setter 2 may set only some of the other web pages Wa, Wc, and Wd (for example, those whose directory distance is equal to or smaller than a predetermined value) as the target web pages.

Then, the sensory distance calculator 3 calculates sensory distances and semantic distances between the reference web page Wb and the other target web pages Wa, Wc, and Wd. Further, the output controller 5 displays the calculated sensory distance and semantic distance in association with each target web page. Specifically, the output controller 5 displays the calculated sensory distance and the calculated sensory distance in the fields for displaying the sensory distance and the semantic distance in the table illustrated in FIG. 20B. In FIG. 20B, for example, the sensory distance between the reference web page Wb and the target web page Wa is “2”, and the semantic distance is “3”. The semantic distance of the reference web page Wb may be “0” as illustrated, may be “-” (hyphen), or does not have to be displayed. In any case, it is desirable to be able to recognize which web page is the reference web page.

Further, the output controller 5 may display a gap between the sensory distance and the semantic distance in association with each target web page. A method of calculating the gap is arbitrary, and the gap is, for example, an absolute value of a difference between the sensory distance and the semantic distance. Here, the web pages may be sorted based on the sensory distance (or the semantic distance) as described with reference to FIGS. 19A to 19C.

In addition, the output controller 5 may issue an alert according to the gap (in other words, depending on the sensory distance and the semantic distance). For example, in a case where there is a target web page whose gap is equal to or larger than a threshold, an alert for specifying the target web page may be issued. In FIG. 20B, assuming that the threshold is 3, an alert indicating that the gap for the target web page Wc is equal to or larger than the threshold is issued. The alert indicates an undesirable state in which the sensory distance is large despite the small semantic distance (that is, the sensory distance needs to be smaller), or the sensory distance is small despite the large semantic distance (that is, the sensory distance needs to be larger).

The gap between the sensory distance and the semantic distance in the above example can have a negative value in a case where the gap is not the absolute value of the difference but is the difference. At this time, a reference for issuing the alert does not have to be determination based on one threshold, but may be the gap within a certain range or outside a certain range.

### <User Setting for Reference for Sensory Distance Calculation>

The user may set a reference for the operation distance described above. A specific example of the method will be described.

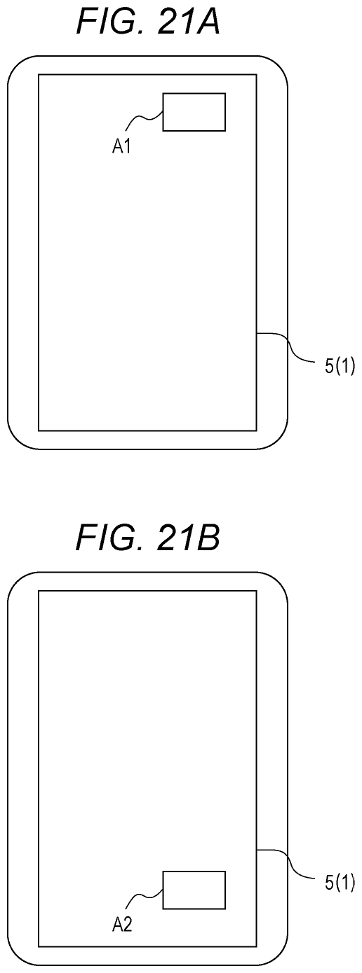

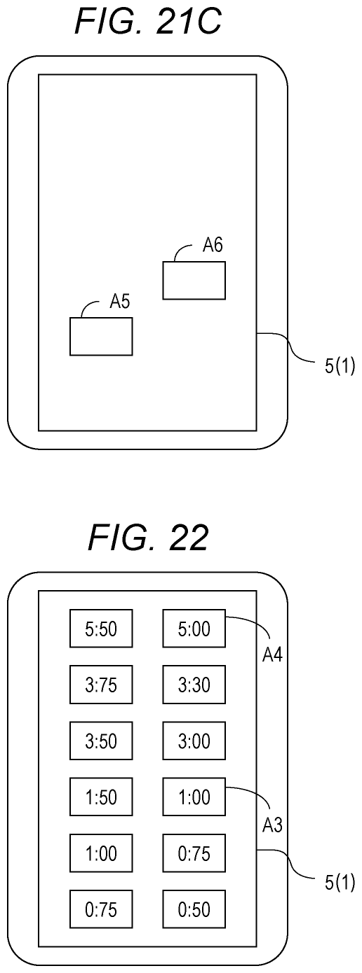

The setter 2 causes an icon A1 to be displayed at a certain position on the display 5 via the output controller 5 (see FIG. 21A). Then, the user selects the displayed icon A1 via the input interface 1 as soon as possible. That is, the setter 2 receives selection of the displayed icon A1 from the user. The setter 2 grasps a time from when the icon A1 is displayed on the display 5 to when the icon A1 is selected by the user.

Subsequently, the setter 2 displays an icon A2 at another position on the display 5 (see FIG. 21B). Then, the user selects the displayed icon A2 via the input interface 1 as soon as possible. That is, the setter 2 receives selection of the displayed icon A2 from the user. The setter 2 grasps a time (hereinafter, referred to as “selection time”) from when the icon A2 is displayed on the display 5 to when the icon A2 is selected by the user.

The above processing operation is performed at each position on the display 5. That is, the setter 2 sequentially displays icons at respective positions on the display. Then, the setter 2 receives selection of the displayed icon from the user. The icons may be displayed at all positions on the display 5, or may be displayed only at some positions. In addition, an icon may be displayed at one position a plurality of times.

When the display of the icon at each position on the display 5 and the selection by the user are completed, the setter 2 may display a relationship between the position of the icon and the selection time on the display 2. As an example, a screen containing an icon arranged at each position and a selection time when the icon is displayed at the position is displayed as illustrated in FIG. 22.

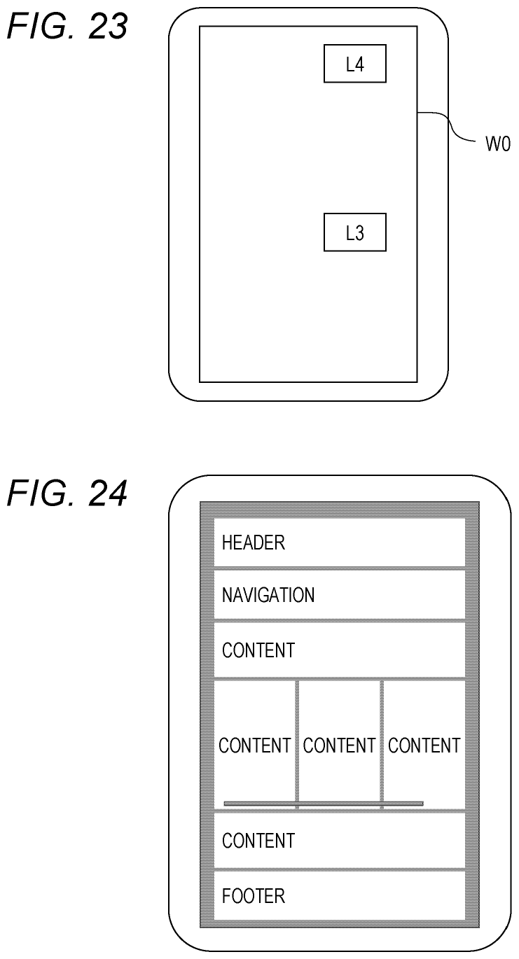

Then, the setter 2 generates a reference for operation distance calculation based on the selection time. As a specific example, the reference is generated in such a way that a target web page associated with a link displayed at a position corresponding to an icon having a larger selection time has a larger operation distance in the reference web page W0. For example, the reference is set in such a way that a sensory distance of a target web page associated with a link L3 (see FIG. 23) displayed at a position corresponding to an icon A3 in FIG. 22 is “1”, and a sensory distance of a target web page associated with a link L4 (see FIG. 23) displayed at a position corresponding to an icon A4 is “5” in the reference web page W0.

The setter 2 may receive in advance a device for displaying the icons illustrated in FIGS. 21A and 21B from the user. For example, in a case of a smartphone, the setter 2 generates a reference for the smartphone.

Furthermore, the setter 2 may receive in advance from the user whether to perform the selection operation with the left hand or with the right hand. For example, in a case where the selection operation is performed with the left hand, the setter 2 generates a reference for the left hand. Then, the sensory distance calculator 3 calculates the operation distance assuming that the selection operation is performed with the left hand.

In addition, the setter 2 may measure a selection success rate (or a failure rate) in addition to the selection time. For example, the success rate is 80% in a case where the icon A1 is displayed at the position illustrated in FIG. 21A ten times, the number of times the icon A1 is correctly selected is eight times, the number of times a place different from the icon A1 is selected is one time, and the number of times the selection operation cannot be performed within a predetermined time limit is one time. Then, the setter 2 may generate the reference in such a way that the higher the success rate, the smaller the operation distance. The success rate (or failure rate) may be displayed on the screen of FIG. 22.

Further, the setter 2 may measure a deviation distance when the selection fails. The deviation distance is a distance between the position of the displayed icon and the position selected by the user. Then, the setter 2 may generate the reference in such a way that the larger the deviation distance, the larger the operation distance. The deviation distance at the time of the selection failure may be displayed on the screen of FIG. 22.

In addition, the setter 2 may simultaneously display a plurality of icons A5 and A6 at a plurality of positions as illustrated in FIG. 21C. Then, the user selects the icons A5 and A6 as soon as possible in the order in which the user feels it is easy to select the icons A5 and A6 via the input interface 1. Then, the setter 2 may first generate the reference in consideration of the selection order. In addition, the setter 2 may generate the reference in consideration of a selection time difference between the icon selected first and the icon selected later. For example, the larger the selection time difference, the larger the difference between an operation distance corresponding to a position of the icon selected first and an operation distance corresponding to a position of the icon selected later.

In addition, the setter 2 may receive a setting of a display aspect (shape, size, color, frame color, frame thickness, or the like) of an icon to be displayed from the user. As a result, it is possible to generate the reference based on the display aspect of the link.

In addition, the setter 2 may receive a setting of a display position of the icon and/or an interval between the icons from the user. The more settings of the display positions and the smaller the set interval, the more accurate reference can be generated. On the other hand, the fewer the settings of the display positions and the larger the set interval, the quicker the reference can be generated.

In addition, the setter 2 may receive, from the user, settings of an icon display speed, an icon display time, the icon display time, the number of icons to be simultaneously displayed, and the order in which the icons are to be displayed. The setter 2 may receive an arbitrary setting from the user and set the reference in consideration of the received information.

Next, an example of reference setting for physical distance calculation will be described.

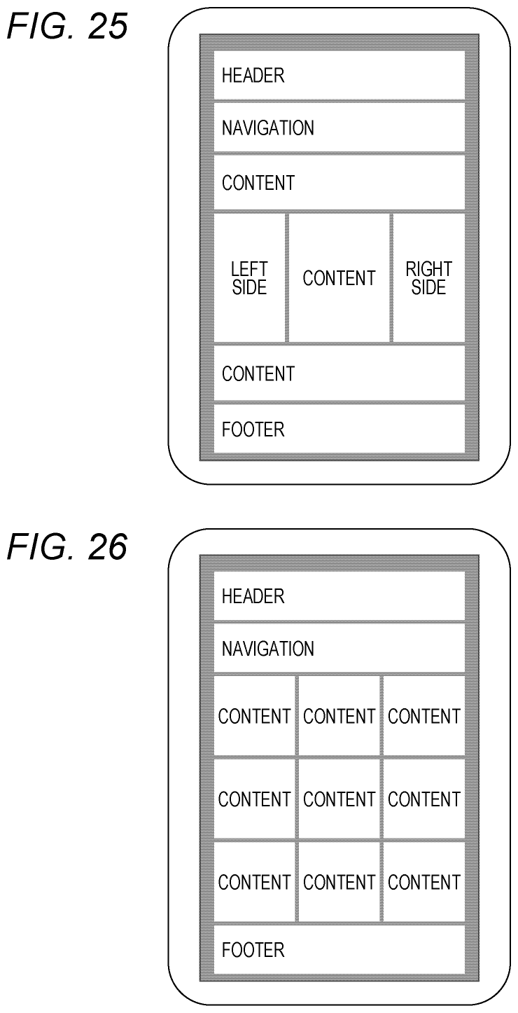

Examples of a layout pattern of a web page contains a single column format (FIG. 24A), a multi-column format (FIG. 25), and a grid format (FIG. 26). For example, a display region of the display is divided into a plurality of regions such as a header part, a navigation part, a content part, and a footer part in the single column format.

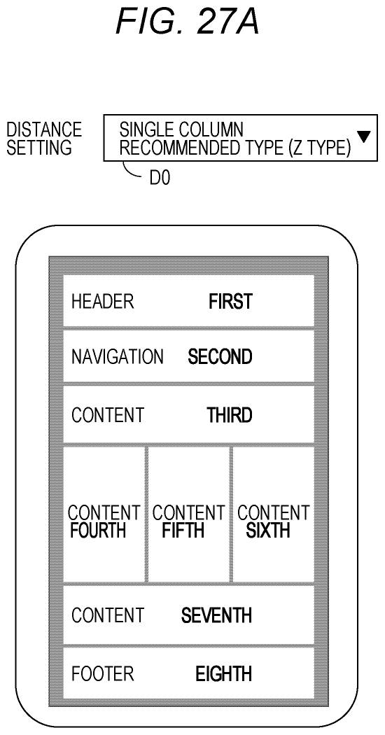

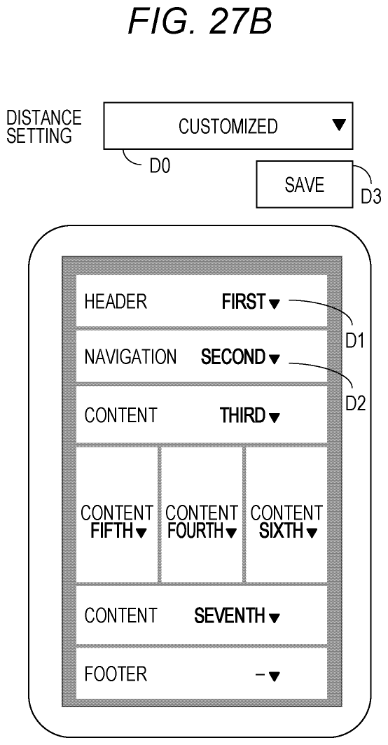

The setter 2 causes the display 5 to display a certain layout pattern via the output controller 5 (the single column format as an example in FIG. 27). In this screen, for example, order setting fields D1 and D2 and the like are provided in the respective regions, and the user can arbitrarily set the order of the physical distances for the regions. For example, the order is set as illustrated in FIG. 27 in a case where the user desires to set the physical distance to be smaller in the order of the header part, the navigation part, the content part (left), the content part (center), the content part (right), the content part (bottom), and the footer part.

In this manner, the setter 2 receives, from the user, a setting of information regarding the length (order) of the sensory distance for each region. Then, the setter 2 generates a reference for physical distance calculation based on the set information. For example, in a case where the reference web page has the single column format, a physical distance to a target web page corresponding to a link arranged in the header part is smaller than a physical distance to a target web page corresponding to a link arranged in the navigation part in the example of FIG. 27.

Furthermore, a plurality of links can be arranged in each region in the layout pattern. Therefore, the setter 2 may generate the reference within the region.

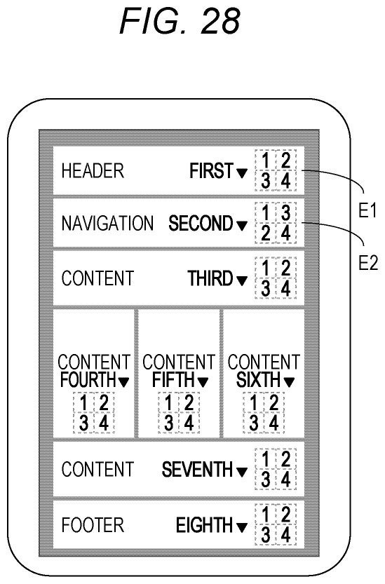

As a specific example, a layout pattern as illustrated in FIG. 28 (the single column format as an example) is displayed on the display 5. In this screen, for example, a plurality of icons E1 and E2 and the like are arranged in each region, and the user can arbitrarily set the order of the physical distances for the icons in the region.

For example, the order is set as illustrated in FIG. 28 in a case where the user desires to set links in the header part to form the Z shape and links in the navigation part to form the inverted N shape.

In this manner, the setter 2 displays icons at the respective positions on the display, and receives, from the user, a setting of information regarding the length (order) of the sensory distance for each icon. Then, the setter 2 generates a reference for physical distance calculation based on the set information. For example, physical distances are calculated to form the Z shape for the plurality of links arranged in the header part, and physical distances are calculated to form the inverted N shape for the plurality of links arranged in the navigation part in a case where the reference web page has the single column format in the example of FIG. 28.

In a case where a plurality of icons are displayed and a setting of the physical distances is received from the user as illustrated in FIG. 28, it is not always necessary to divide the display region into a plurality of regions.

As described above, according to the present embodiment, it is possible to generate information indicating a sensory distance between web pages, which is useful for a site creator.

Although a sensory distance between web pages has been mainly described in the above embodiment, the present invention is also applicable to other than web pages. For example, the present invention is also applicable to a sensory distance between arbitrary screens displayed on the display. As a more specific example, a sensory distance from a certain reference screen to a target screen may be calculated to generate sensory distance information in an application, a game, an automatic teller machine (ATM) monitor, or the like in which transition between a plurality of screens is made. Furthermore, the present invention is applicable not only to web pages or screens but also to a sensory distance between arbitrary electronic media.

Although transition by link selection has been described in the above embodiment, the present invention is applicable to transition by an arbitrary user event such as a speech, a gesture, or a line of sight.

The program referred to in the present specification may be distributed by being non-transitorily recorded in a computer-readable recording medium, may be distributed via a communication line (including wireless communication) such as the Internet, or may be distributed in a state of being installed in an arbitrary terminal.

Each invention described in the present specification is not limited to the embodiments described above, and various additions, modifications, combinations, and partial deletions can be made as appropriate.

For example, what is described herein as a single apparatus (including what is depicted as a single apparatus in the drawings) may be implemented by a plurality of apparatuses.

Further, a part of one embodiment may be incorporated into another embodiment as large as no contradiction arises. Furthermore, not all of the items described in the present specification are essential requirements. In particular, what is described herein and not claimed is an arbitrary additional matter.

The present applicant merely knows the invention disclosed in the literature in the section “Citation List” in the present specification, and each invention disclosed in the present specification is not necessarily intended to solve the problem in the invention disclosed in the literature. The problem to be solved by the invention described in the claims should be recognized in consideration of the entire specification. For example, in the present specification, in a case where a predetermined effect is exhibited by a specific configuration (including a case where the effect can be read from the configuration in addition to a case where there is an explicit description), it can be said that the problem to be a reverse side of the predetermined effect is solved. However, such a specific configuration is not necessarily an essential requirement.

### REFERENCE SIGNS LIST

1 Input interface
2 Setter
3 Sensory distance calculator
4 Site map generator
5 Output controller
6 Display

1.-40. (canceled)

41. A computer readable non-transitory medium storing a sensory distance information generation program causing a computer to perform a method comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between a display position of the interface and the sensory distance is set in advance, and
the sensory distance is calculated based on the display position of the interface and the reference.

42. The medium of claim 41, wherein the reference is set such that as the display position of the interface is higher, or positioned further to left, the sensory distance becomes shorter.

43. A computer readable non-transitory medium storing a sensory distance information generation program causing a computer to perform a method comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between the user operation required to access the interface and the sensory distance is set in advance, and
the sensory distance is calculated based on the user operation required to access the interface and the reference.

44. The medium of claim 43, wherein the reference is set such that as a movement distance of an operation device required to access the interface is shorter, or a number of user operations on an operation device required to access the interface, the sensory distance becomes shorter.

45. A computer readable non-transitory medium storing a sensory distance information generation program causing a computer to perform a method comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between a display aspect of the interface and the sensory distance is set in advance, and
the sensory distance is calculated based on the display aspect of the interface and the reference.

46. The medium of claim 45, wherein the reference is set such that as the interface is larger, thicker, or darker, the sensory distance becomes shorter.

47. A computer readable non-transitory medium storing a sensory distance information generation program causing a computer to perform a method comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference is set in advance such that as a time taken for a user to become accessible to the interface, the sensory distance becomes shorter, and
the sensory distance is calculated based on the time taken for the user to become accessible to the interface and the reference.

48. A computer readable non-transitory medium storing a sensory distance information generation program causing a computer to perform a method comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference is set in advance such that as a time from when a user accesses the interface to transit to a screen linked to the interface, the sensory distance becomes shorter, and
the sensory distance is calculated based on the time from when the user accesses the interface to transit to the second screen and the reference.

49. The medium of claim 41, wherein the method further comprises generating sensory distance information indicating the first screen and the second screen based on the sensory distance.

50. A sensory distance information generation apparatus comprising:
a calculator that calculates a sensory distance for transitioning from a first screen to a second screen, and calculating a semantic distance indicating how close a content of the first screen and the second screen is; and
an issuer that issues an alert in a case where the sensory distance and the semantic distance satisfy a first relationship, wherein
the first screen is transited to the second screen by a user operation on an interface contained in the first screen,
a reference regarding a relationship between a display position of the interface and the sensory distance is set in advance, and
the sensory distance is calculated based on the display position of the interface and the reference.

51. A sensory distance information generation method performed by at least one computer, comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between a display position of the interface and the sensory distance is set in advance, and
the sensory distance is calculated based on the display position of the interface and the reference.

52. A sensory distance information generation apparatus comprising:
a calculator that calculates a sensory distance for transitioning from a first screen to a second screen, and calculating a semantic distance indicating how close a content of the first screen and the second screen is; and
an issuer that issues an alert in a case where the sensory distance and the semantic distance satisfy a first relationship, wherein
the first screen is transited to the second screen by a user operation on an interface contained in the first screen,
a reference regarding a relationship between the user operation required to access the interface and the sensory distance is set in advance, and
the sensory distance is calculated based on the user operation required to access the interface and the reference.

53. A sensory distance information generation method performed by at least one computer, comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between the user operation required to access the interface and the sensory distance is set in advance, and
the sensory distance is calculated based on the user operation required to access the interface and the reference.

54. A sensory distance information generation apparatus comprising:
a calculator that calculates a sensory distance for transitioning from a first screen to a second screen, and calculating a semantic distance indicating how close a content of the first screen and the second screen is; and
an issuer that issues an alert in a case where the sensory distance and the semantic distance satisfy a first relationship, wherein
the first screen is transited to the second screen by a user operation on an interface contained in the first screen,
a reference regarding a relationship between a display aspect of the interface and the sensory distance is set in advance, and
the sensory distance is calculated based on the display aspect of the interface and the reference.

55. A sensory distance information generation method performed by at least one computer, comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference regarding a relationship between a display aspect of the interface and the sensory distance is set in advance, and
the sensory distance is calculated based on the display aspect of the interface and the reference.

56. A sensory distance information generation apparatus comprising:
a calculator that calculates a sensory distance for transitioning from a first screen to a second screen, and calculating a semantic distance indicating how close a content of the first screen and the second screen is; and
an issuer that issues an alert in a case where the sensory distance and the semantic distance satisfy a first relationship, wherein
the first screen is transited to the second screen by a user operation on an interface contained in the first screen,
a reference is set in advance such that as a time taken for a user to become accessible to the interface, the sensory distance becomes shorter, and
the sensory distance is calculated based on the time taken for the user to become accessible to the interface and the reference.

57. A sensory distance information generation method performed by at least one computer, comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference is set in advance such that as a time taken for a user to become accessible to the interface, the sensory distance becomes shorter, and
the sensory distance is calculated based on the time taken for the user to become accessible to the interface and the reference.

58. A sensory distance information generation apparatus comprising:
a calculator that calculates a sensory distance for transitioning from a first screen to a second screen, and calculating a semantic distance indicating how close a content of the first screen and the second screen is; and
an issuer that issues an alert in a case where the sensory distance and the semantic distance satisfy a first relationship, wherein
the first screen is transited to the second screen by a user operation on an interface contained in the first screen,
a reference is set in advance such that as a time from when a user accesses the interface to transit to a screen linked to the interface, the sensory distance becomes shorter, and
the sensory distance is calculated based on the time from when the user accesses the interface to transit to the second screen and the reference.

59. A sensory distance information generation method performed by at least one computer, comprising:
calculating a sensory distance for transitioning from a first screen to a second screen, and calculating a semantic distance indicating how close a content of the first screen and the second screen is; and
issuing an alert in a case where the sensory distance and the semantic distance satisfy a first relationship, wherein
the first screen is transited to the second screen by a user operation on an interface contained in the first screen,
a reference is set in advance such that as a time from when a user accesses the interface to transit to a screen linked to the interface, the sensory distance becomes shorter, and
the sensory distance is calculated based on the time from when the user accesses the interface to transit to the second screen and the reference.
